(19) United States
(12) Patent Application Publication
(10) Pub. No.: US 2025/0285242 A1
(43) Pub. Date: Sep. 11, 2025

(54) METHOD FOR THE FULL CORRECTION OF THE SHARPNESS OF AN IMAGE, AND ASSOCIATED SYSTEM

(71) Applicant: FOGALE NANOTECH, Nîmes (FR)

(72) Inventors: Eric LEGROS, Nîmes (FR); Sylvain PETITGRAND, Caissargues (FR)

(21) Appl. No.: 18/862,119

(22) PCT Filed: May 12, 2023
(86) PCT No.: PCT/EP2023/062843

§ 371 Date: Oct. 31, 2024

(30) Foreign Application Priority Data
May 13, 2022 (FR) FR2204555

(51) Int. Cl. G06T 5/73; G06T 5/70; G06T 5/80

(52) U.S. Cl. CPC G06T 5/73; G06T 5/70; G06T 5/80; G06T 2207/10024

(57) ABSTRACT

A method for correcting at least one input image Iₑ into a rendered image I_{Rk} and then into a rendered image I_{R}, each image originating from an optical sensor provided with photosites of different colors and being obtained through an optical imaging system, each sensor associated with an optical imaging system, the method involving:
receiving each input image Iₑ,
iteratively modifying the image I_{Rk} being rendered at different iterations k, by iteratively processing of a function E comprising two terms, i.e. a first term D, which depends on a comparison between each input image Iₑ and a result I_{ck} of the image I_{Rk} being rendered at the iteration k reprocessed by information relating to the imaging system, and a second term P, which depends on anomalies or penalties or defects within the image I_{Rk} being rendered at the iteration k, until the function E is reduced.

### TECHNICAL FIELD

The present invention concerns a method for correcting the sharpness of an image. It further relates to a system for implementing such a method.

Such a device enables a user to fully correct the sharpness of an image. The field of the invention is more particularly, but non-limitatively, that of digital cameras for mobile phones, tablets, or laptops.

### PRIOR ART

The effect of the diaphragm in photography is well known.

When you reduce the “numerical aperture” of a lens, its light-gathering diameter decreases. A removable hollow disk(s) in the center, or a device for continuously varying the diameter of the aperture (e.g. based on 6 shutters operated simultaneously), is usually used to sharpen the image.

Similarly, for a person needing vision correction, increasing the brightness of the scene being viewed will enable them to see more clearly. Analysis shows that in bright light, the iris contracts, forcing light to pass further into the center of the lens of the eye. This is a “natural diaphragm”.

The theory of optical propagation explains that the closer the optical beams pass to the center of one or more aligned lenses, the more all the propagated beams converge at a single point called the optical focus, for example.

A second beneficial aspect arises when the numerical aperture of an imaging system is reduced: the image becomes sharper and sharper with depth (which can be likened to a so-called Z-axis or optical axis of the lens): in other words, as the beam moves before and after the ideal focal point of convergence, it also produces a sharper image.

Thus, at the extreme, if the aperture of the diaphragm is reduced to an extremely small area, the image can be as sharp on the “foreground”, that is, close-up objects, as on the background, or on the landscape in the distance.

However, photographers often increase the aperture to compensate for a drop in brightness, and/or to reduce image capture time, especially when there is movement in the scene. On the other hand, foregrounds and backgrounds become blurred.

Handling a diaphragm in front of a lens therefore involves compromises between depth of field, luminosity, and image capture time, all of which are mutually contradictory.

The question is how to achieve the same effects as reducing the aperture diameter of the lens, without suffering the same disadvantages, that is, being able to reduce the time needed to take the image (if there is motion so as not to see trails around the image), and/or if the luminosity requires the lens to capture more light, in order to obtain the sharpest image everywhere.

To resolve this issue, we are familiar with the focus bracketing method, which consists in taking multiple images of the same scene at different focus distances. Also known is “focus stacking”, which involves combining different views using image processing to keep only the sharpest areas.

However, focus bracketing and focus stacking are generally unsuitable when part of the scene under observation moves or changes, because combining images then amounts to combining different objects with each other.

The aim of the present invention is to provide a method for correcting the sharpness of an image, preferably anywhere in the image, without the need for long exposure times or for multiple images to be superimposed.

### DISCLOSURE OF THE INVENTION

This objective is achieved with a method for correcting the sharpness of at least one input image Iₑ into a rendered image I_{R}, the at least one input image Iₑ originating from at least one optical sensor and being obtained through at least one optical imaging system, each sensor being associated with an optical imaging system, said method comprising:
receiving the at least one input image Iₑ comprising different points or areas imaging different imaged parts located at different distances from the sensor that acquired the point or area in question,
acquisition or determination, by technical processing means, of information relating, for each point or area coordinate (a, b) of at least one input image Iₑ, to:
   a distance Z0 between, on the one hand, the imaged part corresponding to this point or area of the at least one input image Iₑ and, on the other hand, the imaging system or sensor that acquired this point or area of the at least one input image Iₑ
   a setting of the at least one imaging system for the at least one input image Iₑ or a distance d0 between the sensor and the imaging system that acquired this point or area of the at least one input image Iₑ
a selection or construction, by the technical processing means, of a function F(d0, Z0, a, b) describing the response of the at least one imaging system, preferably optical transfer (OTF) or point spread (PSF) of the at least one imaging system, and which depends, for each point or area coordinate (a, b) of the at least one input image Iₑ:
   on the distance Z0 between, on the one hand, the imaged part corresponding to this point or area of the at least one input image Iₑ and, on the other hand, the imaging system or sensor that acquired this point or area of the at least one input image Iₑ
   on the setting of the at least one imaging system for the at least one input image Iₑ or the distance d0 between the sensor and the imaging system that acquired this point or area of the at least one input image Iₑ
   and preferably on coordinates (a, b)
an application, by the technical processing means, of the function F(d0, Z0, a, b) or of an inverse invF(d0, Z0, a, b) of the function F(d0, Z0, a, b) to each point or area coordinate (a, b) of the at least one input image Iₑ, to obtain the rendered image I_{R}.

The inverse invF(d0, Z0, a, b) of the function F(d0, Z0, a, b) is preferably defined so that the convolution product of the inverse invF(d0, Z0, a, b) of the function F(d0, Z0, a, b) and the function F(d0, Z0, a, b) is a two-dimensional Dirac function or substantially a two-dimensional Dirac function.

The function F(d0, Z0, a, b) may depend on a numerical aperture of the at least one imaging system for acquiring the at least one input image Iₑ.

Each optical sensor can be fitted with photosites of different colors.

The function describing the response of the at least one imaging system can be an optical transfer function (OTF) of the at least one imaging system or a point spread function (PSF) of the at least one imaging system.

The function describing the response of the at least one imaging system may depend:
on a distance (Z) between the at least one sensor and an object imaged by the at least one sensor, and/or
on a distance (z_{co}) between a part of the at least one imaging system and the at least one sensor, and/or
on a distance (zₒₛ) between a part of the at least one imaging system and an object imaged by the at least one sensor, and/or
on a state of the at least one imaging system, such as a zoom or focus or numerical aperture setting of the at least one imaging system, and/or
on the pixel of the image being displayed and/or the photosite of the at least one sensor, and/or
on one or more angles between the at least one sensor and the at least one imaging system.

The method according to the invention may comprise passing light through the at least one imaging system to the at least one sensor so as to generate the at least one input image.

The method according to the invention may comprise displaying the rendered image on a screen.

The rendered image may have a resolution greater than or equal to that of the combination of all the photosites of all the colors of at least one sensor.

According to a first variant, the application of the function F(d0, Z0, a, b) can comprise an iterative convolution of the function F(d0, Z0, a, b) with each point or area of the at least one input image Iₑ so as to obtain at each iteration an image being rendered I_{Rk} and then the rendered image I_{R} at the end of the iterations.

According to this first variant:
the iterative convolution may comprise an iterative modification of the image I_{Rk} being rendered at different iterations k, by iterative processing of a function E comprising two terms including:
   a first term D which depends on a comparison between, on the one hand, the at least one input image Iₑ and, on the other hand, a result I_{ck} of the image I_{Rk} being rendered at iteration k reprocessed by information relating to the at least one imaging system, and
   a second term P which depends on anomaly(ies) or penalty(ies) or defect(s) within the image I_{Rk} being rendered at iteration k, until a cumulative effect is minimized, at least below a certain minimization threshold or after a certain number of iterations, the effect being cumulative of:
   difference(s) in the first term D between the at least one input image Iₑ and the result I_{ck}, and
   anomaly(ies) or penalty(ies) or defect(s) on which the second term P depends within the image I_{Rk} being rendered at iteration k so that the rendered image I_{R} corresponds to the image being rendered at the iteration for which this minimization is obtained.

Thus, by such iteration and minimization, the first variant of the method according to the invention can simultaneously correct at least two of the following types of defects of the at least one input image from:
Optical, geometric and/or chromatic aberration, and/or
Distortion, and/or
Mosaic artifacts, and/or
Detection noise, and/or
Blur, and/or
Residual non-compensation for motion, and/or
Artifacts induced by spatial discretization.

This avoids the disadvantages of successive defect corrections:
They are very time-consuming, and/or
They can accentuate or generate a defect (for example, after a blurring treatment, a noise reduction treatment can reintroduce blurring into the image).

In addition, such a full iterative method leaves open the possibility of obtaining a corrected image resolution equal to or even lower than the photosite resolution limit (although in some embodiments the corrected image resolution may be higher than the photosite resolution limit).

Minimizing the cumulative effect may correspond to minimizing function E.

Function E may comprise (or even consist of) the sum of the first term D and the second term P.

The first term D may depend on the difference(s) between, on the one hand, the at least one input image Iₑ and, on the other hand, the result I_{ck} of a modification of the image I_{Rk} being rendered at iteration k at least by the function F(d0, Z0, a, b) describing the response of the at least one imaging system.

The result I_{ck} may comprise and/or consist of a convolution product of the image I_{Rk} being rendered at iteration k by the function describing the response of the at least one imaging system, and possibly processed by a geometric transformation GT.

The first variant of the method according to the invention can comprise the generating, from multiple input images, of an initial version of the image being rendered I_{Rk} for the first iteration k=1 by a combination between such multiple input images Iₑ.

The second term P may comprise at least one component P₁ whose effect is minimized for small differences in intensity between neighboring pixels of the image I_{Rk} being rendered at iteration k.

The second term P may comprise at least one component P₃ whose effect is minimized for small differences in hue between neighboring pixels of the image I_{Rk} being rendered at iteration k.

The second term P may comprise at least one component P₂ whose effect is minimized for low frequencies of direction changes between neighboring pixels of the image I_{Rk} drawing a contour.

According to a second variant, the application of the inverse invF(d0, Z0, a, b) of the function F(d0, Z0, a, b) may comprise a convolution, preferably non-iterative, of the inverse invF(d0, Z0, a, b) of the function F(d0, Z0, a, b) with each point or area of the at least one input image Iₑ.

Another aspect of the present invention relates to a computer program comprising computer instructions, which when executed by a computer, implement the steps of the method according to the invention.

Another aspect of the invention relates to a computer program product comprising instructions which, when the program is executed by a computer, cause the computer to perform the steps of the method according to the invention.

Another aspect of the invention relates to a computer-readable storage medium comprising instructions which, when executed by a computer, cause the computer to perform the steps of the method according to the invention.

According to yet another aspect of the invention, a device is proposed for correcting the sharpness of at least one input image Iₑ into a rendered image I_{R}, the at least one input image Iₑ originating from at least one optical sensor and being obtained through at least one optical imaging system, each sensor being associated with an optical imaging system, said method comprising:
means for receiving the at least one input image Iₑ comprising different points or areas imaging different imaged parts located at different distances from the sensor that acquired the point or area in question,
technical processing means arranged and/or programmed for acquiring or determining information relating, for each point or area coordinate (a, b) of the at least one input image Iₑ, to:
   a distance Z0 between, on the one hand, the imaged part corresponding to this point or area of the at least one input image Iₑ and, on the other hand, the imaging system or sensor that acquired this point or area of the at least one input image Iₑ
   a setting of the at least one imaging system for the at least one input image Iₑ or a distance d0 between the sensor and the imaging system that acquired this point or area of the at least one input image Iₑ
the technical processing means being further arranged and/or programmed for:
a selection or construction of a function F(d0, Z0, a, b) describing the response of the at least one imaging system, preferably optical transfer (OTF) or point spread (PSF) of the at least one imaging system, and which depends, for each point or area coordinate (a, b) of the at least one input image Iₑ:
   on the distance Z0 between, on the one hand, the imaged part corresponding to this point or area of the at least one input image Iₑ and, on the other hand, the imaging system or sensor that acquired this point or area of the at least one input image Iₑ
   on the setting of the at least one imaging system for the at least one input image Iₑ or the distance d0 between the sensor and the imaging system that acquired this point or area of the at least one input image Iₑ
   and preferably on coordinates (a, b)
an application of the function F(d0, Z0, a, b) or of an inverse invF(d0, Z0, a, b) of the function F(d0, Z0, a, b) to each point or area coordinate (a, b) of the at least one input image Iₑ, to obtain the rendered image I_{R}.

The inverse invF(d0, Z0, a, b) of the function F(d0, Z0, a, b) is preferably defined so that the convolution product of the inverse invF(d0, Z0, a, b) of the function F(d0, Z0, a, b) and the function F(d0, Z0, a, b) is a two-dimensional Dirac function or substantially a two-dimensional Dirac function.

The function F(d0, Z0, a, b) may depend on a numerical aperture of the at least one imaging system for acquiring the at least one input image Iₑ.

Each optical sensor can be fitted with photosites of different colors.

The function describing the response of the at least one imaging system can be an optical transfer function (OTF) of the at least one imaging system or a point spread function (PSF) of the at least one imaging system.

The function describing the response of the at least one imaging system may depend:
on a distance (Z) between the at least one sensor and an object imaged by the at least one sensor, and/or
on a distance (z_{co}) between a part of the at least one imaging system and the at least one sensor, and/or
on a distance (zₒₛ) between a part of the at least one imaging system and an object imaged by the at least one sensor, and/or
on a state of the at least one imaging system, such as a zoom or focus or numerical aperture setting of the at least one imaging system, and/or
on the pixel of the image being displayed and/or the photosite of the at least one sensor, and/or
on one or more angles between the at least one sensor and the at least one imaging system.

The device according to the invention can comprise the at least one sensor and the at least one imaging system which is arranged for light to pass through the at least one imaging system to the at least one sensor so as to generate the at least one input image.

The device according to the invention may comprise means arranged and/or programmed to display the rendered image on a screen.

The rendered image may have a resolution greater than or equal to that of the combination of all the photosites of all the colors of at least one sensor.

According to a first variant, the application of the function F(d0, Z0, a, b) can comprise an iterative convolution of the function F(d0, Z0, a, b) with each point or area of the at least one input image Iₑ so as to obtain at each iteration an image being rendered I_{Rk} and then the rendered image I_{R} at the end of the iterations.

According to this first variant:
the technical processing means are preferably arranged and/or programmed for iterative modification of the image I_{Rk} being rendered at different iterations k, by iterative processing of a function E comprising two terms of which:
   a first term D which depends on a comparison between, on the one hand, the at least one input image Iₑ and, on the other hand, a result I_{ck} of the image I_{Rk} being rendered at iteration k reprocessed by information relating to the at least one imaging system, and
   a second term P which depends on anomaly(ies) or penalty(ies) or defect(s) within the image I_{R} being rendered at iteration k, until a cumulative effect is minimized, at least below a certain minimization threshold or after a certain number of iterations, the effect being cumulative of:
   difference(s) in the first term D between the at least one input image Iₑ and the result I_{ck}, and
   anomaly(ies) or penalty(ies) or defect(s) on which the second term P depends within the image I_{Rk} being rendered at iteration k so that the rendered image I_{R} corresponds to the image being rendered at the iteration for which this minimization is obtained.

The processing means can be arranged and/or programmed to simultaneously correct at least two of the following types of defects in the at least one input image from:
Optical, geometric and/or chromatic aberration, and/or
Distortion, and/or
Mosaic artifacts, and/or
Detection noise, and/or
Blur, and/or
Residual non-compensation for motion, and/or
Artifacts induced by spatial discretization.

Minimizing the cumulative effect may correspond to minimizing function E.

Function E may comprise (or even consist of) the sum of the first term D and the second term P.

The first term D may depend on the difference(s) between, on the one hand, the at least one input image Iₑ and, on the other hand, the result I_{ck} of a modification of the image I_{Rk} being rendered at iteration k at least by the function F(d0, Z0, a, b) describing the response of the at least one imaging system.

The result I_{ck} may comprise and/or consist of a convolution product of the image I_{Rk} being rendered at iteration k by the function describing the response of the at least one imaging system, and possibly processed by a geometric transformation GT.

The processing means may be arranged and/or programmed to generate, from several input images, an initial version of the image being rendered I_{Rk} for the first iteration k=1 by a combination between such multiple input images Iₑ.

The second term P may comprise at least one component P₁ whose effect is minimized for small differences in intensity between neighboring pixels of the image I_{Rk} being rendered at iteration k.

The second term P may comprise at least one component P₃ whose effect is minimized for small differences in hue between neighboring pixels of the image I_{Rk} being rendered at iteration k.

The second term P may comprise at least one component P₂ whose effect is minimized for low frequencies of direction changes between neighboring pixels of the image I_{Rk} drawing a contour.

According to a second variant, the application of the inverse invF(d0, Z0, a, b) of the function F(d0, Z0, a, b) may comprise a convolution, preferably non-iterative, of the inverse invF(d0, Z0, a, b) of the function F(d0, Z0, a, b) with each point or area of the at least one input image Iₑ.

According to yet another aspect of the present invention, the following is proposed:
a smartphone (also called a computer-phone or smart cell phone or multifunction cell phone), implementing a correction method according to the invention to correct an image acquired by the smartphone (more precisely by the camera module(s), comprising a lens and a sensor, of the smartphone) and/or comprising a correction device according to the invention arranged and/or programmed to correct an image acquired by the smartphone (more precisely by the camera module(s), comprising a lens and a sensor, of the smartphone), and/or
use of a correction device according to the invention and/or a correction method according to the invention within a smartphone (also called a computer-phone or smart cell phone or multifunction cell phone), to correct an image acquired by the smartphone (more precisely by the camera module(s), comprising a lens and a sensor, of the smartphone), and/or
a touch-sensitive tablet, implementing a correction method according to the invention to correct an image acquired by the touch-sensitive tablet (more precisely by the camera module(s), comprising a lens and a sensor, of the touch-sensitive tablet) and/or comprising a correction device according to the invention arranged and/or programmed to correct an image acquired by the touch-sensitive tablet (more precisely by the camera module(s), comprising a lens and a sensor, of the touch-sensitive tablet), and/or
use of a correction device according to the invention and/or a correction method according to the invention within a touch-sensitive tablet, to correct an image acquired by the touch-sensitive tablet (more precisely by the camera module(s), comprising a lens and a sensor, of the touch-sensitive tablet), and/or
a camera (preferably of the reflex or bridge or compact type), implementing a correction method according to the invention to correct an image acquired by the camera (more precisely by the camera module(s), comprising a lens and a sensor, of the camera) and/or comprising a correction device according to the invention arranged and/or programmed to correct an image acquired by the camera (more precisely by the camera module(s), comprising a lens and a sensor, of the camera),
use of a correction device according to the invention and/or a correction method according to the invention within a camera (preferably of the reflex or bridge or compact type), to correct an image acquired by the camera (more precisely by the camera module(s), comprising a lens and a sensor, of the camera), and/or
a vehicle (preferably automotive, but may be of any type), implementing a correction method according to the invention to correct an image acquired by the vehicle (more precisely by the camera module(s), comprising a lens and a sensor, of the vehicle) and/or comprising a correction device according to the invention arranged and/or programmed to correct an image acquired by the vehicle (more precisely by the camera module(s), comprising a lens and a sensor, of the vehicle); the corrected image preferably being used or intended to be used by the vehicle for autonomous driving of the vehicle, and/or
use of a correction device according to the invention and/or of a correction method according to the invention within a vehicle (preferably automotive, but may be of any type), to correct an image acquired by the vehicle (more precisely by the camera module(s), comprising a lens and a sensor, of the vehicle); the corrected image preferably being used or intended to be used by the vehicle for autonomous driving of the vehicle, and/or
a video surveillance system (preferably of a building and/or a geographical area), implementing a correction method according to the invention to correct an image acquired by the video surveillance system (more precisely by the camera module(s), comprising a lens and a sensor, of the video surveillance system) and/or comprising a correction device according to the invention arranged and/or programmed to correct an image acquired by the video surveillance system (more precisely by the camera module(s), comprising a lens and a sensor, of the video surveillance system), and/or
use of a correction device according to the invention and/or a correction method according to the invention within a video surveillance system (preferably of a building and/or a geographical area), to correct an image acquired by the video surveillance system (more precisely by the camera module(s), comprising a lens and a sensor, of the video surveillance system), and/or
a drone, implementing a correction method according to the invention to correct an image acquired by the drone (more precisely by the camera module(s), comprising a lens and a sensor, of the drone) and/or comprising a correction device according to the invention arranged and/or programmed to correct an image acquired by the drone (more precisely by the camera module(s), comprising a lens and a sensor, of the drone); the corrected image preferably being used or intended to be used by the drone:
   in the field of agriculture, the image acquired by the drone preferably being an image of plant crops, and/or
   in the field of pollution and/or land use analysis, the image acquired by the drone preferably being a multispectral image, and/or
use of a correction device according to the invention and/or a correction method according to the invention within a drone, to correct an image acquired by the drone (more precisely by the camera module(s), comprising a lens and a sensor, of the drone); the corrected image preferably being used or intended to be used by the drone:
   in the field of agriculture, the image acquired by the drone preferably being an image of plant crops, and/or
   in the field of pollution and/or land use analysis, the image acquired by the drone preferably being a multispectral image, and/or
a satellite, implementing a correction method according to the invention to correct an image acquired by the satellite (more precisely by the camera module(s), comprising a lens and a sensor, of the satellite) and/or comprising a correction device according to the invention arranged and/or programmed to correct an image acquired by the satellite (more precisely by the camera module(s), comprising a lens and a sensor, of the satellite); the corrected image preferably being used or intended to be used by the satellite:
   in the field of agriculture, the image acquired by the satellite preferably being an image of plant crops, and/or
   in the field of pollution and/or land use analysis, the image acquired by the satellite preferably being a multispectral image, and/or
use of a correction device according to the invention and/or a correction method according to the invention within a satellite, to correct an image acquired by the satellite (more precisely by the camera module(s), comprising a lens and a sensor, of the satellite); the corrected image preferably being used or intended to be used by the satellite:
   in the field of agriculture, the image acquired by the satellite preferably being an image of plant crops, and/or
   in the field of pollution and/or land use analysis, the image acquired by the satellite preferably being a multispectral image, and/or
an apparatus for medical imaging of the human and/or animal body (preferably by MRI and/or X-ray and/or Gamma-ray and/or ultrasound), implementing a correction method according to the invention to correct an image acquired by the medical imaging apparatus and/or comprising a correction device according to the invention arranged and/or programmed to correct an image acquired by the medical imaging apparatus, and/or
use of a correction device according to the invention and/or a correction method according to the invention within a medical imaging device for imaging the human and/or animal body (preferably by MRI and/or X-ray and/or Gamma-ray and/or ultrasound), to correct an image acquired by the medical imaging device, and/or
a microscopy apparatus, implementing a correction method according to the invention to correct an image acquired by the microscopy apparatus and/or comprising a correction device according to the invention arranged and/or programmed to correct an image acquired by the microscopy apparatus, and/or
use of a correction device according to the invention and/or a correction method according to the invention within a microscopy apparatus, to correct an image acquired by the microscopy apparatus, and/or
an apparatus for tomographic imaging of an image acquired in multiple spectra (preferably in the field of health and/or in the field of industry and/or in the field of agriculture), implementing a correction method according to the invention to correct an image acquired by the tomographic imaging apparatus and/or comprising a correction device according to the invention arranged and/or programmed to correct an image acquired by the tomographic imaging apparatus, and/or
use of a correction device according to the invention and/or a correction method according to the invention within a tomographic imaging apparatus of an image acquired in multiple spectra (preferably in the field of health and/or in the field of industry and/or in the field of agriculture), to correct an image acquired by the tomographic imaging apparatus.

### DESCRIPTION OF THE FIGURES AND EMBODIMENTS

Other benefits and features shall become evident upon examining the detailed description of entirely non-limiting embodiments and implementations, and from the following enclosed drawings:

FIG. 1 shows various steps 2, 5, 7, 8 of a preferential embodiment of method 1 according to the invention,

FIG. 2 shows various steps 2, 5, 7, 8, 11, 12, 13 of the preferential embodiment of method 1 according to the invention, and

FIG. 3 shows a possible representation of pixel objects in method 1: a pixel with three color properties R, G, B. Its position is that of its X,Y position, represented by the indexing to access it, which translates its position in the image I_{Rk} or I_{R}.

FIG. 4 is a schematic view of various parts 3, 4, 6 of a correction device embodiment according to the invention.

These embodiments are in no way limiting, and in particular, it is possible to consider variants of the invention that comprise only a selection of the features disclosed hereinafter in isolation from the other features disclosed (even if that selection is isolated within a phrase comprising other features), if this selection of features is sufficient to confer a technical benefit or to differentiate the invention with respect to the prior state of the art. This selection comprises at least one preferably functional feature which lacks structural details, and/or only has a portion of the structural details if that portion is only sufficient to confer a technical benefit or to differentiate the invention with respect to the prior state of the art.

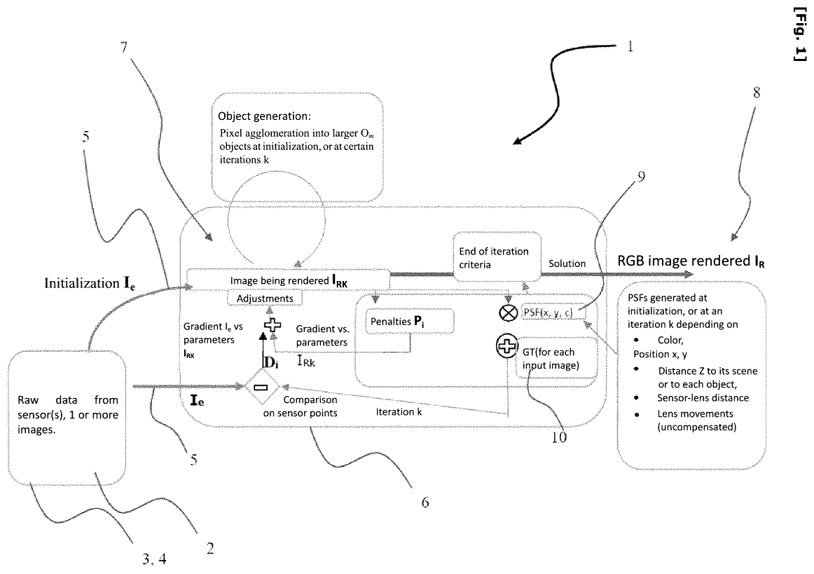

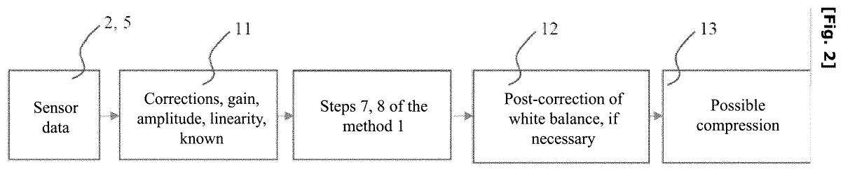

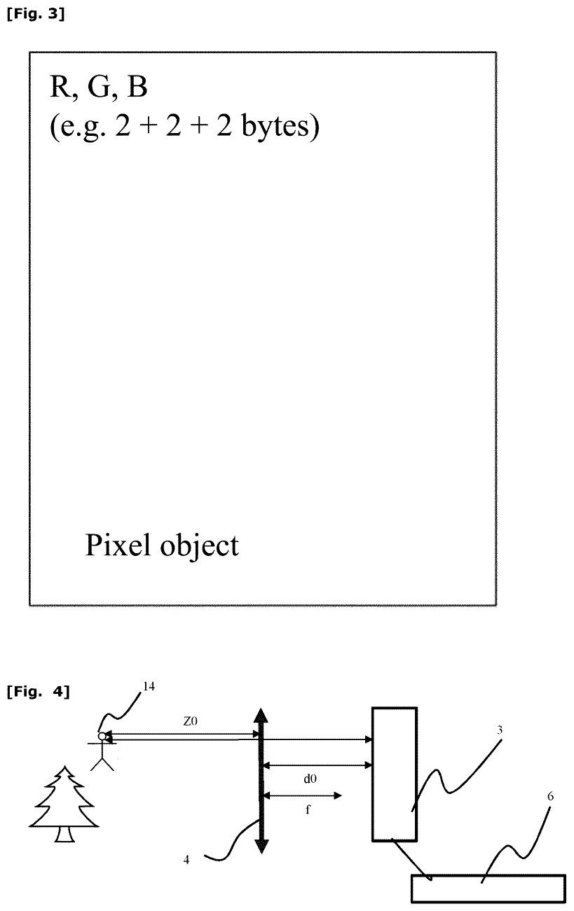

With reference to FIGS. 1 to 4, the main steps of one embodiment of a correction method 1 according to the invention will first be described by an embodiment of a device according to the invention comprising the means 6 (and also preferably 3 and 4) described below.

The method 1 is a method for correcting the sharpness of at least one input image Iₑ into a rendered image I_{R}, the at least one input image Iₑ originating from at least one optical sensor 3 and being obtained through at least one optical imaging system 4, each sensor 3 being associated with an optical imaging system 4, said method comprising:
reception, by means 6, of at least one input image Iₑ comprising different points or areas imaging different parts 14 of the imaged scene located at different distances from the sensor 3 that acquired the point or area in question (these different parts may be different parts of the same body or object, for example the hand, chin, eyes, etc. of the same person);
acquisition or determination, by technical processing means 6, of information relating, for each point or area coordinate (a, b) of the at least one input image Iₑ, to:
   a distance Z0 (sometimes also noted Z or Zo in the present description) between, on the one hand, the imaged part corresponding to this point or area of the at least one input image Iₑ and, on the other hand, the imaging system or sensor that acquired this point or area of the at least one input image Iₑ
   a setting of the at least one imaging system for the at least one input image Iₑ or a distance d0 between the sensor and the imaging system that acquired this point or area of the at least one input image Iₑ
a selection or construction, by the technical processing means 6, of a function F(d0, Z0, a, b) describing the response of the at least one imaging system, preferably optical transfer (OTF) or point spread (PSF) of the at least one imaging system, and which depends, for each point or area coordinate (a, b) of the at least one input image Iₑ:
   on the distance Z0 between, on the one hand, the imaged part corresponding to this point or area of the at least one input image Iₑ and, on the other hand, the imaging system or sensor that acquired this point or area of the at least one input image Iₑ
   at least one of:
      a setting of the at least one imaging system for the at least one input image Iₑ, such as the focal length f of the at least one imaging system for the at least one input image Iₑ, or the numerical aperture of the at least one imaging system for the at least one input image Iₑ, or
      the distance d0 between the sensor and the imaging system that acquired this point or area of the at least one input image Iₑ
   and preferably coordinates (a, b) (that is, for a value of Z0 identical for all coordinates (a, b) and an identical value of d0 or the setting of the at least one imaging system identical for all coordinates (a, b), the value of the function F(d0, Z0, a, b) still varies as a function of the coordinates (a, b))
application, by the technical processing means 6, of the function F(d0, Z0, a, b) (first variant) or of an inverse invF(d0, Z0, a, b) (second variant) of the function F(d0, Z0, a, b) to each coordinate (a, b) of a point or area of the at least one input image Iₑ, to obtain the rendered image I_{R}, so as to improve the sharpness of the rendered image I_{R} relative to the at least one input image Iₑ, preferably for each point or area of the rendered image I_{R}.

Preferably:
the at least one input image Iₑ comprises a single input image, and
the at least one optical sensor 3 comprises a single sensor 3, and
the at least one optical imaging system 4 comprises a single optical imaging system 4, preferably a lens 4.

The case of multiple input images Iₑ, possibly produced by multiple sensors 3, each equipped with a dedicated optical imaging system 4, does not correspond to “focus bracketing” or “focus stacking”, but preferably to multiple input images Iₑ (preferably acquired simultaneously) of different scenes, which can be joined edge-to-edge to construct a large rendered image I_{R} (larger than each of the input images Iₑ) by combining the various input images Iₑ.

The inverse invF(d0, Z0, a, b) of the function F(d0, Z0, a, b) is preferably defined such that the convolution product of the inverse invF(d0, Z0, a, b) of the function F(d0, Z0, a, b) and the function F(d0, Z0, a, b) is a two-dimensional Dirac function (that is, preferably a matrix with only one term or coefficient other than 0) or substantially a two-dimensional Dirac function (that is, preferably:
a matrix whose set of coefficients does not represent any significant luminous information apart from a single location or a highly concentrated area in the vicinity of a single location, e.g. the discretization of a Gaussian function whose half-width is less than or of the order of the distance between two pixels, and/or
a matrix wherein no more than 10% of the terms or coefficients are non-zero).

The function F(d0, Z0, a, b) may depend on a numerical aperture of the at least one imaging system for acquiring the at least one input image Iₑ.

The question of method 1 is therefore: how to achieve the same sharpness effects as reducing the aperture diameter of the lens, without suffering the same disadvantages, that is, being able to reduce the time needed to take the image (if there is motion so as not to see trails around the image), and/or if the luminosity requires the lens to capture more light? And how can these benefits be achieved even in a single image capture, even if parts of the scene are moving, or even if the whole scene is moving relative to the capture system (such as a digital camera)?

The method 1 thus makes it possible to maintain a maximum numerical aperture for the lens 4. This makes it possible to keep image capture time as short as possible, and/or to capture an image in low-light conditions. It also delivers an image that is sharp in all its parts, particularly in the foreground, background and, of course, in between.

To implement the method 1, preferentially knowledge of the optical transfer function F(d0, Z0, a, b), called PSF, is recommended. It is recommended to know this PSF according to multiple geometrical parameters such as:
at least one of:
   the distance d0 between the lens 4 and image sensor 3 (usually a matrix of photosensors called a CMOS image sensor),
   which may amount to the same thing, a setting on the lens 4, such as the distance f of the lens 4, where the objects observed appear sharpest, or the numerical aperture of the lens 4.
the distance Z0 between the observed objects 14 and the lens 4, or equivalently, the distance between these observed objects 14 and the image sensor 3.
But also, preferably, the position in the image field. In fact, the PSF also varies when the observed point corresponds to a set of optical rays moving away from the lens' axis of symmetry. Generally speaking, the greater this distance, the more a point in the scene is projected onto the image sensor 3 in one large task. This position can be identified by two coordinates, for example a and b, depending on the row and column of the pixel of the sensor 3 corresponding to the observed point. The center of the image can then be identified as a=b=0. It is also possible to consider the mean angles of the rays arriving on the lens (α and β), which correspond bijectively to a and b. (α=a/d0 and β=b/d0 where d0 is the distance between the center of the lens and the image sensor, and generally d0˜f is the focal length of the lens.)

Other parameters can be added, such as the numerical aperture of the lens, if an adjustable diaphragm is maintained in front of it, since the PSF depends on it.

The PSF can be represented by a matrix of coefficients, corresponding to the light intensity received on the sensor pixels in the projected illumination area of the corresponding point in the scene.

Alternatively (variant 2), another matrix known as invPSF, potentially wider than PSF, may also be known. This invPSF is to be calculated in such a way that the spatial convolution product of the two matrices invPSF and PSF (filling in the missing coefficients to 0 to enable this convolution), gives a matrix with one or very few non-zero coefficients. This function is said to approach a two-dimensional Dirac function.

As an alternative to knowing the PSF or invPSF function according to the at least 4 parameters d0, Z, a, b, it may be sufficient to consider the PSF obtained from d0 and Z, assuming it to be uniform according to a and b. It is also possible to consider the PSF corresponding to an ideal lens generating, for example, a Gaussian beam whose only input parameters are the distance to the lens and the lens' numerical aperture.

A sharp image is obtained everywhere, even for large diaphragm apertures, or from the lens itself, as if a very small aperture had been added in front of the lens.

This is despite the fact that the image may have been obtained in front of a scene potentially in motion, and with maximum lighting conditions.

In this way, a sharp image can be obtained anywhere, from a single image.

The at least one input image Iₑ had been derived from acquisition 2 by at least one optical sensor 3 equipped with photosites of different colors. Each sensor 3, more precisely each photosite of each sensor, is arranged to convert received photons into an electrical signal. Different photosites are said to have different colors if they have different properties for converting photons into an electrical signal, depending on the wavelength of the photons. The “color” of a photosite corresponds to the wavelength of the photons for which the photosite will have the best or substantially the best rate of converting these photons into electrical energy. An example of sensor 3 is a digital camera sensor.

The at least one input image Iₑ is obtained through at least one optical imaging system 4. Each imaging system 4 can typically be a system comprising multiple lenses, potentially movable relative to one another for focus and/or zoom adjustment, and making up an imaging system of a camera, a webcam, or a reflex, bridge, or compact digital camera, of a smartphone, tablet, laptop, etc. This imaging system can therefore be compact to a varying extent, with more or fewer lenses of various possible materials (glass, plastic, etc.) with different optical indices, etc.

Hereinafter, the term “camera module” shall refer to an assembly comprising a sensor 3 and an imaging system 4.

The sensor 3 or each of the sensors 3 is associated with the optical imaging system 4 or with one of the optical imaging systems 4. In other words, there is typically a set or system of lenses 4 in front of each sensor 3.

Thus, the method 1 comprises a passage of light through the at least one imaging system 4 to the at least one sensor 3 so as to generate the at least one input image Iₑ, typically one image Iₑ per sensor 3 provided with a system 4.

The method 1 comprises reception 5 of the at least one input image Iₑ, by technical means 6 such as technical calculation and/or analysis and/or processing means 6.

The means 6 comprise at least one of the following: a computer, a central processing or computing unit, an analog electronic circuit (preferably dedicated), a digital electronic circuit (preferably dedicated), and/or a microprocessor (preferably dedicated), and/or software means.

### First Variant

According to a first variant, the method 1 is a method for correcting at least one input image Iₑ into an image being rendered I_{Rk} and then a rendered image I_{R}.

According to the variant 1, it is then necessary to:
estimate the parameters of each area or point of the image, in particular: their coordinates (a, b), the current distance d0, and the distance Zo, between the lens and the observed point in the scene.
generate PSF(d0, Zo, a, b)
it is then possible to iteratively convolve each PSF with each image area, to compare it with the resulting image, and to upgrade the so-called rendered image.
The result is a flat image I_{R}, which is sharp everywhere.

The method 1 further comprises an iterative modification 7 (by technical means 6 which are arranged and/or programmed to do so) of the image I_{Rk} being rendered at different iterations numbered k (k being a positive natural number from 1 to N, where N is the total number of iterations), by iterative processing of a function E comprising two terms (more precisely, comprising or even consisting of the sum of the first term D and the second term P) of which:
a first term D which depends on a comparison between, on the one hand, the at least one input image Iₑ and, on the other hand, a result I_{ck} of the image I_{Rk} being rendered at iteration k reprocessed by information 9 relating to the at least one imaging system 4, and
a second term P which depends on anomaly(ies) or penalty(ies) or defect(s) within the image I_{Rk} being rendered at iteration k, until a cumulative effect is minimized, at least below a certain minimization threshold or after a certain number of iterations (the minimization of the cumulative effect corresponding to minimization of the function E), the effect being cumulative of:
difference(s) in the first term D between the at least one input image Iₑ and the result I_{ck}, and
anomaly(ies) or penalty(ies) or defect(s) on which the second term P depends within the image I_{Rk} being rendered at iteration k so that the rendered image I_{R} (by means 6 in a rendering step S of the rendered image) corresponds to the image I_{Rk} being rendered at the iteration for which this minimization is obtained.

This rendering step S may be followed by:
a step 12 of post-correction of the image I_{R} (white balance, etc.) and/or
a step 13 of compressing I_{R}

In the case of multiple sensors 3 or of a sensor generating multiple images Iₑ, the means 6 (which are arranged and/or programmed to) generate, from such multiple input images Iₑ, the initial version of I_{Rk} for the first iteration k=1 by a combination between such multiple input images Iₑ, which makes it possible, for example, to produce a “panoramic” image I_{Rk} for k=1 by combining multiple smaller images Iₑ originating from the different sensors 3.

This method 1 is therefore implemented by a processing loop 7 acting directly between the input image Iₑ (possibly corrected (step 11) by offsets and gain, or even non-linearities, that are directly available), and the image I_{Rk} being rendered, which is generated by directly taking into account a maximum number of elements that accurately model the geometry of all parts of the at least one sensor 3, the optical focusing effects of the at least one sensor 3, any movements and the effects of distances modifying the focusing effects.

The at least one image Iₑ comprises one or more input images, taken:
by the same system of camera(s) 3 & lens(es) 4, with a single input image, or multiple images, or
by multiple lenses 4, such as those, for example, of a smartphone equipped with multiple cameras 4, taken at similar, or close, moments.

In more detail, the method 1 for processing images Iₑ is therefore based on the following inputs:
1) the at least one input image Iₑ. Each input image Iₑ uses or directly comprises the intensities of the photosites R (Red), G (Green), B (Blue) (or according to another possible choice of color matrix such as R (Red), Y (Yellow), W (White), B (Blue)) of the sensor 3 associated with this image Iₑ, preferably before any noise reduction operation by spatial smoothing, which is no longer necessary, or any attempt to restore missing color, which is also no longer necessary (except in special cases). This image is called an input image Iₑ. However, it may also preferably comprise taking into account (step 11) the gain and black level information of the photosites, for example according to a table of values specific to the detection sensor, photosite by photosite, (or region by region, as the case may be), that is, the intensities detected by the photosites will preferably have been corrected to have the same numerical level of black rendering, and a level of rendering of a homogenized reference white, e.g. a uniform one, or according to a reference frame in line with the subsequent point spread function correction processing. Should the detection prove to be non-linear, compressing high intensities for example, method 1 can make these corrections also in this so-called input image Iₑ, although these calculations can also be performed in the iteration loop 7 if this is of interest, and it can be if non-linearity or saturation relationships are complex. Doing them at this stage means they only need to be done once per image, and is therefore potentially advantageous in terms of computational volume. Finally, if any photosites are deemed non-functional, they should be excluded from the comparison steps in the calculations of gradients with respect to the distance D or distances Di described later.
2) information 9 generated from a relatively precise knowledge of the optical focusing faults of the lens 4 or the at least one imaging system 4, and preferably also differentially for each color channel detected. This information may involve reading a table giving access to particular information linked to the defects in the design of the lens 4 or the at least one imaging system 4, as well as the conditions of use of the lens 4 or the at least one imaging system 4, such as the distance between each lens or system 4 and the scene observed through this lens or system 4, either considered according to a single distance, or differentiated into object-by-object distance from the scene, and the distance between the lens or system 4 and the imaging sensor 3 associated with this lens or system 4, and possibly angle variations between these elements. This information is used to synthesize a rendering of point spread functions 9 (known as PSFs), which can be represented by matrices of coefficients capable of producing, by convolution with the intensities ideally emitted by each point of the scene, the intensities obtained at the image sensor 3 or at least at one sensor 3, for each color channel. In the event that uncompensated or only partially compensated displacement faults are known, for example through a representation of the residual non-compensated movement of the camera module relative to the scene, the PSF 9 matrices at different positions are summed, weighted by the time that has elapsed there, to calculate a composite PSF 9 including these residual uncompensated movements, and use this form of PSFs 9 as an input element for image rendering iterations. To obtain the movement trajectory of a sensor 3, it is sufficient, for example, for an acceleration sensor to record the movements of the device containing the camera module during image capture, and if the image is mechanically stabilized in relation to the movements of the device containing the camera module, it would be sufficient for the absolute residual of non-stabilization to be calculated in relation to the acceleration sensor and the stabilization signal. In another implementation, in the absence of direct motion measurement data, the image is analyzed to determine the result of the displacement trajectory and to deduce therefrom the composition to be applied to the PSFs to offset this motion. In this way, the image I_{R} is also compensated for the blurring effects of residual, uncompensated movement.
3) When the system has multiple input images Iₑ (from the same or separate modules), a so-called geometric transformation (GT) entity, referred to as GT or 10 in this description and in the figures, provides a channel for geometrically transforming each scene to make it spatially coincide with the various other images. This GT 10 is generally non-linear to take account of distortion differences between camera modules if there are a plurality of them and the modeling of geometric distortions is not perfect, or if the scene has moved relative to the camera module(s) between the different images. When there is only one image, the GT can be taken as the identity. With multiple images Iₑ as input, we can consider one of the images as untransformed and calculate the GT for the others. Each other GT of each image can be calculated by, for example, looking for correlation maxima by shifting parts of an input image Iₑ relative to another, e.g. the first in the series, and keeping the translation that produced the best correlation. This operation must be repeated on multiple parts of each image, but not necessarily on all parts of the image. Preferably, the resulting translation field is interpolated by a method such as linear interpolation, or preferably cubic interpolation, or any other method that allows such interpolation. All these interpolations are used to obtain complete coverage of the image field for each GT operator.

Rendering 8 comprises displaying the rendered image I_{R} on a screen, by display means forming part of the device embodiment according to the invention.

The rendered image I_{R} has a resolution greater than or equal to that of the combination of all the photosites of all the colors of at least one sensor 3.

In a preferential implementation, the image processing method 1 can render an image I_{R} with a resolution at least as high as that of the individual photosites of the different colors, or even higher, in order, among other things, to reduce the effects of aliasing.

Thus, the method 1 (by technical means 6 which are arranged and/or programmed to do so) simultaneously corrects at least two of the following types of defect in the at least one input image from:
Optical, geometric and/or chromatic aberration, and/or
Distortion, and/or
Mosaic artifacts, and/or
Detection noise, and/or
Blur, and/or
Residual non-compensation for motion relative to a scene, and/or
Artifacts induced by spatial image discretization.

In its full implementation, this image rendering method 1 compensates for optical projection errors on the sensor 3 or at least one sensor 3, and reduces light intensity detection noise. In particular, it also compensates for mosaic effects on sensors 3 with spatially separated detection of multiple colors, and can also effectively compensate for residual movements of a camera module relative to the scene.

The method 1 is therefore based on a full processing of rendering operations, unlike prior art, which proceeds in successive steps, with the inherent shortcomings mentioned above. This method 1 can take as input the data of the image detected by at least one sensor 3 in a first channel, called an ‘input image’ Iₑ, and also in a second channel, called ‘optical aberration data’ 9 in the form of so-called PSF matrices, of optical distortion data provided by the lens or the at least one imaging and focusing system 4 under the relative position conditions of the other optical elements (sensors 3, and scene elements), that data being precise enough to know these defects at the scale of the light projection on each photosite. In particular, it is preferable to calculate the PSFs 9 as a function of the distances to the various objects in the scene, in order to obtain compensation for these optical aberrations that takes account of the actual focusing distance of each object photographed, thereby increasing the effective depth of field when the image is rendered compared to the prior art.

In this way, the method 1, in its most complete implementation, provides an output image known as a rendered image I_{R}. In particular, this image I_{R} has no mosaic artifacts, significant noise reduction according to a setting to be adjusted if necessary, correction of position distortion and image blur adapted to each image region, compensation of relative movements between the lens 4 or the at least one imaging system 4 and the observed scene, for its most complete embodiment, which makes the most of the method 1.

Compared with the prior art, the method 1 means that dissociated correction steps are no longer stacked on top of each other, thus avoiding the effects of combining defects inherent in each step. It also makes it possible to limit the scope of the effects of the assumptions that this prior art was led to make, such as the small spatial variation of each color around the detected color photosites to interpolate the values that should have been detected in the absent photosites (because they were at the location of one of the other detected colors).

Different variants (which may be combined with one another) of the method according to the invention are therefore conceivable:
Alternatively, if the at least one image sensor 3 does not generate any mosaic artifacts, for example thanks to a technology for detecting different color channels at the same location, or because it would still be preferable to remove mosaic artifacts by interpolation or some other method for obtaining color values at locations where photosites are physically missing, the method 1 uses that un-mosaiced data. It continues to provide very good image rendering quality, for example by continuing to reduce noise and blur in the image, and possibly also to reduce deformation distortions with respect to the ideal homothety, for example, if the PSF 9 data presented to the method comprises this distortion information. It will even provide additional demosaicing, if necessary, if only partial demosaicing of input data has been carried out.
In another variant, where detection comprises mosaicing, it is still preferable to present the undemosaiced data to method 1, as the generation of spatially denser image information relative to the input mosaic can be more accurate and involve fewer or no artifacts, depending on the implementation settings of method 1, whereas prior art demosaicing will comprise more artifacts.
In a non-preferred implementation variant (as it would leave blur uncorrected), method 1 comprises only noise and distortion reduction, without necessarily correcting the aberrations leading to blur. In this case, all that is needed in the convolution channel with PSF 9 is a translation in the (X, Y) plane of the values of a pixel in the rendered image according to the distortion information, without taking blur effects into account. Formally, this would be equivalent to convolving with a PSF 9 matrix having only one or a few non-zero coefficients, by not retranscribing in that location the entire point spread as a whole linked to the point spread information in the PSF matrix presented to the method. To simplify matters, it is possible to simply translate the value of a pixel rather than multiplying it by zero at certain points to model geometric distortion information. Gradient operations need to be expressed in such a way as to take these translations into account in the calculation modes, in order to obtain the desired effects on the rendered image.
In one variant, if reducing image noise leads to a reduction in the rendering of details that are not noise, or for any other reason that would make it undesirable to reduce noise using the method, one may simply modify the weighting of the penalty(s) leading to noise compression in the rendered image I_{R} to leave this aspect in the rendered image, or, if necessary, construct one or more penalty criteria that are less sensitive to noise (for example, by constructing penalties so as to be only sensitive to aliasing effects on the edges of objects in the image, but not to color or luminosity jumps within objects).

The first term D depends on the difference(s) between, on the one hand, the at least one input image Iₑ and, on the other hand, the result I_{ck} of a modification of the image I_{Rk} being rendered at iteration k at least by the function F(d0, Z0, a, b) (also referenced as 9) describing the response of the at least one imaging system.

The first term D may comprise the sum of multiple terms Di.

Preferably, each distance component Dᵢ (1 if i max=1) is calculated as many times as there are different image captures, and summed together, either directly or with weighting coefficients between image captures.

In order to obtain the best possible results from this method 1, a preferably precise knowledge of the optical transfer function 9 is useful, spatially in the image field and also in relation to other possible parameters of relative distance of the optical elements scene, lens, sensor(s) 3, such as among other things the knowledge of the optical transfer functions 9 (representable by PSF matrices) are possibly differentiated in relation to different distances to objects in the scene.

The result I_{ck} comprises and/or consists of a convolution product of the image I_{Rk} being rendered at iteration k by the function 9 describing the response of the at least one imaging system, and possibly processed by the geometric transformation GT (referenced 10).

With reference to FIG. 1, GT (capture p) is the geometric transformation for each image capture p, for example, one which models a relative movement of the scene with respect to the camera module(s) 3,4 (for example, it is the camera module that moves in the case where the scene is a landscape, which is therefore fixed), and/or models another projection onto another camera module. This GT ( ) can model a difference in distance between the 2 modules, if the latter is not integrated into the PSF 9.

The coefficients of the PSF( )s can be slightly modified to model the fractional part of scene movement, which does not correspond to the PSF grid step, in special cases where this parameter is fixed. But in the case of an object-based implementation representing the image, this remark is not necessary, as the convolution at the PSF must adapt anyway to non-aligned coordinates on a particular grid for each object. In the latter case, GT acts on a local movement of each object and its outline. If the object is large, GT ( ) can also distort its appearance by applying different movements to its various parts.

The GT function can be placed before or after the convolution of I_{Rk} with the PSF 9. Preferentially, it can be placed afterward, to avoid repeating convolution operations for each input image.

The function 9 describing the response of the at least one imaging system 4 is an optical transfer function (OTF) of the at least one imaging system or a point spread function (PSF) of the at least one imaging system.

The function 9 describing the response of the at least one imaging system depends:
on a distance (Z) between the at least one sensor 3 and an object imaged by the at least one sensor 3, and/or
on a distance (z_{co}) between a part of the at least one imaging system 4 and the at least one sensor 3, and/or
on a distance (zₒₛ) between a part of the at least one imaging system 4 and an object imaged by the at least one sensor 3, and/or
on a state of the at least one imaging system 4, such as a zoom or focus or numerical aperture setting of the at least one imaging system 4, and/or
on the pixel of the image being displayed and/or the photosite of the at least one sensor 3, and/or
on one or more angles between the at least one sensor 3 and the at least one imaging system 4.

The second term P comprises:
at least one component P₁ whose effect is minimized for small differences in intensity between neighboring pixels of the image I_{Rk} being rendered at iteration k, and/or
at least one component P₃ whose effect is minimized for small differences in hue between neighboring pixels of the image I_{Rk} being rendered at iteration k, and/or
at least one component P₂ whose effect is minimized for low frequencies of direction changes between neighboring pixels of the image I_{Rk} drawing an outline.

The second term P may thus comprise a sum of a plurality of terms Pi.

Now the details of implementing the method 1 will be examined.

The method 1 involves representing the image I_{R}, known as the rendered image, or the image being rendered I_{Rk}, in a table of values known as the rendering table. It contains color values at discretized positions, for example according to the three colors R (red), G (green), B (blue), or in another reference frame. These elements can be seen as juxtaposed square or rectangular elementary objects, with three (or n_{c}) color properties, in addition to the element width and length properties common to all these elements, as well as the position property implicitly known by an arrangement in row succession in the table and at a constant pitch in each x and y direction (x and y, also noted as X and Y, being two orthogonal directions in the plane of the image called a rendered image I_{R} or image being rendered I_{Rk}). These objects can be called pixels.

This table represents elementary objects, preferably with a resolution equal to or greater than that of the combination of all the photosites of all the colors of the at least one sensor 3. It can have a scanning and positioning pitch offset from the photosites of the at least one sensor 3, but preferably in spatial synchronization therewith. For example, for a color filter array (CFA) of 4 photosites R (Red), G1 (Green 1), G2 (Green 2), B (Blue), arranged in 2×2 rows and columns, it can have a numerical representation, for each of the three color properties R (Red), G (Green), B (blue), of one pixel opposite R (Red), then of one pixel opposite G1, G2, B, that is, a total of 4 pixels comprising an R, G, B channel, spatially matching the 4 photosites R, G1, G2, B of detection, and repeated as many times as necessary in the x and y directions to describe the entire sensor 3 associated with the image Iₑ.

It is also possible to double the number of rendering pixels in each X and Y direction, which would make 16 pixels rendering Red, Green, Blue for each CFA elementary cell. This ratio, known as oversampling, has a value here of 2×2=4 for both x and y directions at the same time (if the CFA elemental pattern comprises 2×2 photosites). Other ratios would obviously be possible.

It would also be possible to downsample, although this would not improve the rendering quality of the image I_{Rk} or I_{R} in terms of sharpness, but would enable good quality of a compressed image I_{R} or I_{Rk} (in terms of number of pixels).

This table can also be supplemented, or replaced by a list of objects describing the image I_{Rk} or I_{R}. Each object can thus be the square or rectangle pixel, or objects with more properties such as an outline, average color components, but also brightness and color gradient components, for example, and a particular shape. This second representation allows greater freedom in representing positions, with coordinates represented by numbers having greater resolution than a collection of pixels at predefined locations. In addition, the colors and intensities of objects superimposed at certain points can be added together.

Formally, the rendered image I_{Rk} at iteration k (I_{Rk}) is written as the sum of the nₘ objects Oₘₖ representing it:

$${I}_{R k} = {\sum }_{m = 1}^{n m} {O}_{m k} \qquad [ Math . 1 ]$$

The method 1 comprises an output channel for the rendered image I_{R}, which can be a storage of the image being rendered I_{Rk}, at a stage when it is deemed renderable in relation to the rendering process when it is iterative.

In the case where the image I_{Rk} or I_{R} is a sum of different pixel objects, it may be necessary to calculate the value generated by each object for each color, according to the x, y grid chosen to render the image I_{R} image, at the output of the method 1.

Alternatively, the image I_{R} can be output in the form of its objects directly, if this is advantageous in terms of data volume, or in order to obtain a so-called vectorized output format.

The format in which the image I_{R} is rendered may advantageously be in one of the object representations described in the implementation, in order to benefit from all the resolution fineness and pixelation compensation (discretization) permitted.

Similarly, when comparing the distances Di between the convolved image and the PSFs 9, the method 1 can perform this same type of local color evaluation in the objects opposite the PSF discretization grid, so as to know the colors calculated in place of the input image photosite positions in order to make distance comparisons at the right places, without shifting, for maximum rendering accuracy.

We will now describe various possible ways of implementing the method 1. The aim is to build a way of directly taking into account the whole model of optical defects, between the at least one input image Iₑ represented by the values of the different color components of the photosites and the calculation that the optical defects induce at these locations, from the image being rendered I_{Rk}.

The optical defect model 9 is taken into account by calculating the effects it induces on the basis of the image I_{Rk}, by composing this image I_{Rk} with the optical defect model 9, for example by means of a convolution product between the matrix of luminous values of I_{Rk} (at each point of a fairly fine grid), and the point spread matrix called PSF 9 on this same grid, which as output provides a matrix of values according to a grid I_{ck} (a grid which allows comparison with the photosites at sensor 3 corresponding to the input image Iₑ).

Of course, a convolution calculation can be carried out by multiplication in the frequency domain, and it is also possible to take into account the effects of point spreading by the spatial Fourier transforms of PSF matrices 9, generally called OTF (Optical Transfer Function), which then simply need to be multiplied with the fourier transforms of the image being rendered, then returned to the spatial domain by a reverse transform, if this procedure is of interest.

Formally, this is written:

I_{ck}=GT(Iᵣₖ)(*)PSF

where (*) stands for convolution product.

GT( ) can be the identity, or a geometric transformation, which consists in locally moving the elements, either by pixel translation in such a representation, or by equivalent modification of the PSFs by recalculating the set of coefficients to take this transformation into account, or possibly a mixture of the two.

It is also possible to write:

I_{ck}=GT(Iᵣₖ(*)PSF)

which means that the transformation is carried out after applying the PSF. In this case, the advantage is that it is not necessary to recalculate the convolution product for the different images, which limits the amount of calculations.

An example of how to write I_{ck}, to take into account the fact that each point spread function 9, originating from a point (xi, yi) in the scene can produce a different point spread, is:

$${I}_{c k} ( {i}_{c x} , {i}_{c y} , {i}_{c o u l} ) = {\sum }_{{i}_{y} = - Δ y}^{Δ y} {\sum }_{{i}_{x} = - Δ x}^{Δ x} {C}_{rk} ( {i}_{rx} + {i}_{x} , {i}_{r y} + {i}_{y} , c ) * P S F ( {i}_{c x} , {i}_{c y} , {i}_{r x} + {i}_{x} , {i}_{r y} + {i}_{y} )$$

irx and iry are selected to correspond with i_{cx} and i_{cy}.

For example, if the at least one input image Iₑ has a rendered pixel (with 3 colors) opposite each photosite.

where Δx and Δy are values generally much smaller than the number of photosites in the screen, they are chosen to represent the places where point spread produces a significantly non-zero value.

The first 2 indices of the PSF( ) matrix represent the point spread, obtained for a point xi, yi, which would be the luminous value of the scene for that point in the scene that corresponds to this xi, yi of the sensor.

The above calculation therefore comes down to considering the point spread values at the sensor's (xi, yi) locations, by considering the various points in the scene that correspond with the sensor's (xi+x, yi+y) points.

This notion is indexed by physical notations. In a computer representation, there is a tendency to write the PSFs differently, as many coefficients would be zero in xi, yi for the first 2 indices: they are re-centered around the first 2 indices, to obtain physically more compact tables of non-zero values. This is an implementation detail that doesn't change the principle.

I_{ck} is the value of the color component c, at position (xi, yi) obtained on the sensor, at iteration k, therefore as a convolution of the image being rendered, at iteration k, represented by color components Cᵣₖ, at positions (xi+x, yi+y) for color c.

From this calculation, we create a first indicator or term called distance D₁, possibly supplemented by other terms D₂ . . . D_{nd}, resulting from a comparison between I_{ck} and Iₑ, which is denoted D₁ (I_{ck}, Iₑ):

$$D = {D}_{1} ( {I}_{c k} , {I}_{e} ) + {D}_{2} + … + {D}_{n d}$$

$$Or$$

$$D = {D}_{1} ( {I}_{c k} , {I}_{e} )$$

In parallel, one or more penalties (P₁, P₂, . . . . Pₙₚ) are calculated directly from the image Iᵣₖ.

To ensure that the image I_{Rk} is the best possible representation of the observed scene, it is then iterated, hence the index k.

The result is an overall deviation indicator E:

$$E = {\sum }_{i = 1}^{n d} {α}_{i} {D}_{i} + {\sum }_{i = 1}^{n p} {β}_{i} {P}_{i} \qquad [ Math . 3 ]$$

where nd is the number of distances Di,
np is the number of penalties Pi
with, for example:
nd=1
np=1
α₁=1
β₁ which can be adjusted to give more or less weight between the distance that forces conformance to the input image Iₑ (or input images), and the penalty that forces the image I_{Rk} or I_{R} to conform to some other property, or to possess a certain consistency with respect to the images that the camera module or the at least one camera module is supposed to observe, which also amounts to saying that this penalty indicator also makes it possible to select the images that are most likely to be observed among those that will be rendered. For example, it is unlikely to observe an image I_{Rk} or I_{R} comprising red/green/blue “snow” within its textures, and it can be said that the penalty indicator P is constructed to make the appearance of such rendered images I_{R} less likely, when it is constructed to be sensitive to color noise in the image I_{Rk} or I_{R}.

The aim of the method is to obtain a rendered image Iᵣ that minimizes the indicator E.

Except in special cases where the expression of the distance D1 would allow a direct calculation to minimize it, and where the penalty P1 would also allow it, or would be taken to be zero, the general method of resolution can be obtained, for example, by a so-called Newtonian gradient method, which allows the minimum of a function to be found, by varying the input parameters in the inverse of the gradient of a function E, to minimize its value.

At each step, the sum of the derivatives of each term of E with respect to the set of parameters of the rendered image Iᵣₖ is calculated, and the elements of the image I_{Rk} are then made to evolve with respect to this gradient.

The aim of iteration 7 is to modify the Iᵣₖ image at each step, so as to minimize the indicator E.

In addition, preferentially, outline search operations are preferably carried out on the rendered image I_{Rk} or I_{R} in at least some iterations, in order to create, move or modify an outline.

The distance D or distances Di are therefore derived from Irk (*) PSF (or GT (Irk (*) PSF), while P or the Pᵢs are derived directly from the Irks.

At the end of rendering process 8, either the value of E is deemed sufficiently small, or an estimate of the gradients relative to it is sufficiently small, or the number of iterations is limited to estimate that the image obtained is renderable.

The distance Di calculations are preferably based on all photosite positions. It is therefore necessary to calculate the values of the various color intensities from Irk (*) PSF.

The penalties Pᵢ may be calculated at positions not necessarily related to photosite positions. This can be done on the basis of elementary objects, known as pixels in the rendered image, or on the basis of properties of larger objects, without necessarily displaying color properties according to the precise image rendering or PSF grid, for example, but by means of a more general calculation based on object properties.

A first phase of iterative modification 7 consists in generating an initialization of the rendering table values, that is, determining I_{Rk} for k=1. There are multiple possible implementations:
a) One may directly copy the values from the ‘input’ image Iₑ described above. When the image's blur and distortion are minor, this option is preferable in terms of ease of use . . .
b) Preferentially, from the point spread functions (PSF) 9, a certain inversion of the matrix representing it is calculated, at least over the lowest, significant spatial frequencies. From this matrix, denoted iPSF or invPSF, which can preferentially be specific to each wavelength and each position in the field, a convolution product is produced with the values of neighboring photosites from the input image Iₑ to produce a first image value I_{Rk} to initialize the rendering table.
c) In cases where at least one image Iₑ is captured in video mode, or if it is deemed to change slowly, the value of the previous rendered image can also be left as the initialization value for the rendering table, except at the start of the video sequence, when it is preferable to proceed as indicated in cases a or b above.

A second phase of iterative modification 7 (possibly reduced to a single iteration, without initialization) consists in using a direct calculation of I_{Rk} image propagation, through a convolution of the rendering table image with local point spread matrices (PSF) 9, which will preferentially be specific per color channel, per position in the at least one sensor 3, and may also depend on other parameters such as the distance z_{co} between the lens 4 or the at least one imaging system 4 and the sensor 3 or the at least one sensor 3, and between the lens 4 or the at least one imaging system 4 and the various objects in the scene, distance zₒₛ(p), preferably regionalized for each part ‘p’ of the image I_{Rk}, so as to best model the optical transfer function 9 between the scene and the sensor 3 or at least one sensor 3, for its various color channels.

This direct calculation makes it possible to estimate the deviation indicator between the image obtained by the pixels of the sensors 3, and the calculated one. There are various ways of obtaining the image I_{R}:

Either, less preferentially, an inversion in the least squares sense is calculated, in order to find the best image which, convolved by the PSF 9 field described above, provides a minimum “error distance” with respect to the image obtained on the sensor 3 or the at least one sensor 3, for example for the three color channels, weighted with the same weight, or not. In this case, one may refer to known least-squares methods. Note also that initialization may not be necessary, and that there is only one iteration on image rendering (although the method of least squares leads to the generating of a square matrix that needs to be inverted, which is an iteration internal to this calculation and in a way replaces the iterations discussed below).

Or, preferably, in order to obtain a better noise resistance of the rendered image, one proceeds by iteration, starting from the initial value I_{Rk} for k=1 present in the rendering table, which we will change at each step. In order to calculate how the rendering table should evolve, the rendering at each iteration step shall be incremented by the integer k.

In order to guide the evolution of the rendering table of the image I_{Rk}, a first term, for example formally called D₁, is calculated as the sum of squares of the deviations between the conversion table of the rendered image I_{Rk} (image at step k) convolved by the local PSFs. Other distances Di are also possible, such as the sum of absolute values, or any other function that reduces the distance D when the pixel values of the two images come closer together.

When a term of this distance D can be formally derived in order to directly calculate a local matrix of partial derivatives ∂y/∂x of each term of D between the value y of the color at the position of a photosite of the at least one input image Iₑ, and the value x of one of the properties of the elements of the rendered image I_{Rk} or I_{R}, such as its value, it is preferable to do so to limit the calculations. In this case, it's a matter of including terms from local PSF matrices in these calculations.

Alternatively, one may proceed by finite difference, which provides an estimator of the derivative.

These gradients need only be calculated at positions where there are color-measuring photosites in at least one input image Iₑ. At the other locations, the gradient is by definition zero, which means that it can be formally referred to in the present description, but no calculations will need to be performed at these positions.

To clarify the implementation examples in the present description, it is convenient to note that at least two registration spaces can be considered: a so-called ξr space linked to the image being rendered I_{Rk}, a so-called ξc space linked to the input image or images Iₑ of the method 1. In the case of multiple input images Iₑ, multiple spaces can be considered to be called ξce with e being an index to name them.

In the case where the rendered image I_{Rk} or I_{R} is described by a juxtaposition of pixels, for a rectangular shape, ξr can be described by two indices iᵣₓ and i_{ry} which take their values between 1 and nₓᵣ and 1 and n_{yr} respectively, nₓᵣ and n_{yr} being the number of pixels. Other shapes than the rectangle are obviously possible, which can complicate this description of the indices.

The corresponding physical positions can then be written as:

xr(irx,iry)=iᵣₓ*PasImgRx,

yr(irx,iry)=i_{ry}*PasimgRy,

where PasImgRx and PasImgRy are the distances between pixels in the x and y directions. These physical distances remain relative; they depend on the scale at which the image I_{Rk} or I_{R} is rendered. However, they will need to be connected to the physical distances of the image sensor 3 or the at least one sensor 3, to enable PSF 9 convolution calculations at the correct scale, between the rendered image I_{Rk} or I_{R} and the image(s) at the sensor I_{ck}.

Associated with the Er space, the index i_{rcoul} is also introduced, which will be used to index the elements that follow in relation to their properties associated with the color components in the rendered image. For example, i_{coul} can take a value between 1 and 3, 1 for Red, 2 for Green, 3 for Blue in the rendered image. If required, more color components can be rendered, e.g. an infra-red component, an ultra-violet component, the number 3 here being recommended in relation to the 3-color display mode of screens and our human trichromy, which is by no means limiting with regard to other values.

The methods described in procedure 1 can also be applied to a black-and-white (i.e. grayscale) image, in which case i_{coul} is assumed to be 1.

For the input image(s) Iₑ, if it is rectangular, made up of elementary rectangular color acquisition blocks (known as CFAs), it is preferable to identify the precise position of each CFA photosite of each color in relation to a common coordinate, rather than, for example, associating a common coordinate with all the photosites of each color of the same elementary CFA, in order to calculate the value of the rendered image I_{Rk} or I_{R} by transforming the rendered image to the sensor image I_{ck} at the precise position of each color of each photosite. For example, consider a coordinate index system describing the position of each CFA elementary block, then add the offset for the position of each photosite.

For example, let us denote as i_{cx} and i_{cy} the indices in the sensor (‘c’), varying between 1 and n_{xc} and 1 and n_{yc}, respectively. Let us add a 3^{rd} index, i_{coul}, to address the photosite type (coul as color), for example ranging from 1 to 4 for respectively R, G1, G2, B for Red, Green1, Green2, Blue.

The physical position of each photosite is written as:

$${x}_{c} ( {i}_{c x} , {i}_{c y} , {i}_{coul} ) = {i}_{cx} * PasCFAx + PosX ( {i}_{coul} ) ,$$

$${y}_{c} ( {i}_{c x} , {i}_{c y} , {i}_{coul} ) = {i}_{cy} * PasCFAy + PosY ( {i}_{coul} ) ,$$

where PasCFAx represents the displacement between each CFA block in x, and similarly in y for PasCFAy.
and PosX(i_{coul}) marks the physical displacement in the CFA block for the position of each photosite, as does PosY(i_{coul}) for y.

The distance unit is the same for PasCFAx or y and PosX(i_{coul}) or PosY(i_{coul}).

At this point, all that is needed is to express the geometric transformation and optical transfer elements, to take as input the physical positions of the frame of reference associated with ξr, and as output that of the frame of reference associated with ξce. In the case of discretization of these marks by the indices that scan the positions of rendered pixels on one side, and those (the indices) of the photosite blocks (or directly of the photosites) on the other, the optical transfer transformations can take the form of a matrix product, with ad hoc management of the indices to obtain the correspondences of the physical positions between the rendered image and the image perceived at the sensor (or the images at the sensors 3).

If, during geometrical transformation calculations, geometrical transformation offsets provide, for example, positions that shift away from discretized positions (that is, calculated position indices that acquire a non-zero fractional part), it would be ideal to, for example, interpolate pixel values in the rendered image frame, to obtain an input matrix with positions compatible with the PSF matrix, for example, so that the output coefficients of the rendered image (x) PSF convolution correspond to photosite positions, without any offsets. If this precaution is not taken, the quality of the rendered image I_{R} may suffer from defects such as shifts between the rendered colors, resulting, for example, in the appearance of colored fringe residues around the elements of the rendered image, or geometric micro-distortions linked to these fractional parts in the indices of ignored calculated positions.

As an example of the correspondence between ξᵣ space and ξ_{c} space, let us assume that the rendered image I_{Rk} or I_{R} has 1 pixel (that is, 3 colors) opposite each photosite, and that the CFA has 4 photosites R, G1, G2, B.

We can define index offsets (I_{cfa_x}, I_{cfa_y}) to access photosites relative to the CFA origin, by:

$$for {i}_{coul} = 1 ( for R ) , ( {I}_{cfa \_ x} , {I}_{cfa \_ y )} = ( 1 , 0 ) ;$$

$$for {i}_{coul} = 2 ( for G 1 ) , ( {I}_{cfa \_ x} , {I}_{cfa \_ y )} = ( 1 , 1 ) ;$$

$$for {i}_{coul} = 3 ( for G 2 ) , ( {I}_{cfa \_ x} , {I}_{cfa \_ y )} = ( 0 , 0 ) ;$$

$$for {i}_{coul} = 4 ( for B ) , ( {I}_{cfa \_ x} , {I}_{cfa \_ y )} = ( 0 , 1 ) ;$$

We therefore note that i_{coul} does not strictly identify the color received, but rather the position index in the CFA block, which accordingly reveals its color component. Of course, there could be a 5th photosite with infrared dominance and a 6^{th} with ultraviolet dominance, making, for example, 6 possible values for i_{coul}.

For the CFA block (change from rendered image to CFA block):

$${i}_{c x} = 1 + ( {i}_{r x} - 1 ) / 2 \\ \\ {i}_{c y} = 1 + ( {i}_{r y} - 1 ) / 2$$

For an image pixel, using the offsets (I_{cfa_x}, I_{cfa_y}) defined above (change from sensor index to rendered image):

$${i}_{rx} = 1 + ( {i}_{c x} - 1 ) * 2 + {I}_{cfa \_ x} ( {i}_{coul} )$$

$${i}_{ry} = 1 + ( {i}_{cy} - 1 ) * 2 + {I}_{cfa \_ y} ( {i}_{coul} )$$

The function D or D1 can also be summed over sub-regions of the image, for example, with different weightings to adapt the solution found to specific image characteristics. In addition, D1 can be combined with at least one other function, D2, calculated in a different way, to give a different sensitivity in a given amplitude range, for example.

In particular, the color detection matrix may have a different exposure or collection area for green pixels G1 and G2, for example, so that if pixel G1 saturates or is close to saturation in a certain part of the I_{Rk} or I_{R} image, pixel G2 still provides an unsaturated response in this part. Generally speaking, we can group photosites G1 close to saturation under the symbol Phₕₙ(i_{cx}, i_{cy}, i_{coul}) in the expressions below (hn referring to high signal level) and other photosites R, G2, B as well as G1s in dimly lit parts of the image under the symbol Ph_{bn}(i_{cx}, i_{cy}, i_{coul}) (bn referring to low signal level).

In this case, for example, when calculating distance(s) D, consider:

$${D}_{1} = {A}_{1} * {\sum }_{( {i}_{cx} , {i}_{c y} , {i}_{coul} ) ∈ \{ p h o t o s ites near saturation \}} {( {I}_{c k} ( {i}_{cx} , {i}_{cy} , {i}_{c o u l} ) - {Ph}_{h n} ( {i}_{cx} , {i}_{cy} , {i}_{c o u l} ) )}^{2} \qquad [ Math . 4 ]$$

$${D}_{2} = {A}_{2} * {\sum }_{( {i}_{cx} , {i}_{c y} , {i}_{coul} ) ∈ \{ p h o t o sites far from saturation \}} {( {I}_{c k} ( {i}_{cx} , {i}_{cy} , {i}_{c o u l} ) - {Ph}_{bn} ( {i}_{cx} , {i}_{cy} , {i}_{c o u l} ) )}^{2} \qquad [ Math . 5 ]$$

If any photosites are reliably saturated, they should preferably be excluded from the above summations.

The first distance D₁ is therefore calculated with photosites that are close to saturation or potentially saturated (such saturation can, for example, be assessed according to a criterion of significant reduction of the derivative of the relationship between the measured value and the luminosity received, below a certain value), and the second distance D₂ is calculated with the photosites identified as being far from saturation (such absence of saturation may, for example, be assessed according to a criterion of maintaining the derivative of the relationship between the measured value and the luminosity received above a certain value).

I_{ck} is the calculation of the composite (convolved) rendered image with PSF 9 information, and A1 and A2 are two weighting coefficients.

Thus, to take photosite saturation into account, A1 can be significantly attenuated compared to A2 and the rest of the other coefficients (applied to the “penalty” operators), so that the rendered image solution does not take much account of these close or potentially saturated photosites, which would therefore not provide reliable information.

If desired, in order to implement the method 1 in a preferable mode that reduces noise or aliasing effects, at least one further global penalty term P₁ is to be calculated, possibly supplemented by further terms P₂, . . . Pₙ.

This term P₁ may, for example, correspond to a so-called penalty function calculated as follows:
we first name the 3 components in each position of the rendering table Rₖ(iᵣₓ, i_{ry}), Vₖ(iᵣₓ,i_{ry}), Bₖ(iᵣₓ, i_{ry}), also called Cₖ(iᵣₓ, i_{ry}, i_{rcoul}), to bring them together under the index c.

This function P₁ can be the sum over the 3 or nc colors, of the sum over the field (irx, iry) of the absolute values (denoted |.|) of the differences between each component:

$$Delta ( {i}_{r x} , {i}_{r y} , {i}_{coul} ) = \vert {C}_{k} ( {i}_{r x} + 1 , {I}_{r y} , {i}_{rcoul} ) - {C}_{k} ( {i}_{r x} , {i}_{r y} , {i}_{rcoul} ) \vert + \vert {C}_{k} ( {i}_{r x} , {i}_{r y} + 1 , {i}_{rcoul} ) - {C}_{k} ( {i}_{r x} , {i}_{r y} , {i}_{rcoul} ) \vert$$

A derivation of this function P₁ is then evaluated with respect to the value of each pixel of each color, for example where photosites of the measured color exist, or for all discretized positions of x, y.

In the particular example of this implementation, the presence of the absolute values |.| can make it necessary to calculate this gradient numerically (by finite difference), and not simply from a formal derivation of Delta (iᵣₓ, i_{ry}, i_{rcoul}).

This P₁ function has been chosen here because it prevents the solution that will be calculated at each iteration from containing high-frequency noise components, as it tends to increase the value of P₁ when value discrepancies occur between neighboring pixels. In particular, this effect tends to counterbalance the effects of noise present in the original image, and which tend to be replicated in the image rendered from the measurement D₁.

This way of obtaining the penalty P₁ is given as an example only.

It is also possible to construct a penalty operator P₃ (that complements or replaces P₁) that penalizes rapid variations in hue in the image, for example using the formulation:

$$Delta ( {i}_{rx} , {i}_{r y} ) = \vert {U}_{k} ( {i}_{r x} + 1 , {i}_{r y} ) - {U}_{k} ( {i}_{r x} , {i}_{r y} ) \vert + \vert {V}_{k} ( {i}_{r x} , {i}_{r y} + 1 ) - {V}_{k} ( {i}_{r x} , {i}_{r y} ) \vert$$

where U and V are the decompositions in a Chroma 1 (U), Chroma2 (V), Luminance (Y) system, that is, Y=(R+G+B) and U=B−Y and V=R−Y for example (without involving any particular notion of projection on a color rendering diagram, to keep this description simple). (The Green of the image is referred to as G above to avoid confusion with the V value of Chroma 2)

This example for P₃ therefore shows that the penalty excludes the luminance value, which is free to reproduce that of the object observed, but strongly restricts color rendering, where noise is strongly prevented.

These are just two examples, and other less simple ones are also possible, for example by combining more distant pixels together, and assigning different weights to difference calculations for U and V on the one hand, and Y on the other.

P can also be constructed as the minimum of a plurality of penalty functions generated according to other combinations, or functions more complex than multiplications and additions from the color pixels rendered at step k.

At this stage, it is not necessarily necessary to add a penalty P₂ to the calculation of P₁ and/or P₃. But it can be used as a complement, for example to create a penalty on a more global property of the objects in the image being rendered. For example, to create a particular property relating to the outline of the object being rendered (by high contrast detection, for example).

In this way, frequent changes of direction can be minimized in the penalty P₂. It is possible to locally calculate the direction (vector dx, dy) of the local direction of the outline, and calculate an indicator that increases when this direction changes, preferably using a square, or an absolute value to add any change that cannot be offset by a change further away, of opposite sign.

Thus, P₂ increases, for example, if the outline of the luminance Y zigzags. Therefore, in P₂, we can sum the previous locally calculated penalty indicators over the entire field x, y.

In the following, we call Gradient, represented by the operator grad( ) the set of partial derivatives of a distance or penalty of an elementary object Cₖ(iᵣₓ, i_{ry}, i_{rcoul}) of the rendered image, that is, typically the coordinate vector the derivatives of a distance D or Dᵢ or penalty P or Pᵢ with respect to, for example, the set of n_{c} colors of Cₖ(iᵣₓ, i_{ry}, i_{rcoul}), doing so for each x, y, c describing the image, or in the following, the partial derivatives with respect to other properties describing the object Oₘₖ, such as the parameters of its outline, its colors, its color gradients.

Similarly, we calculate grad (P₂) (x, y, c), or its finite difference when derivation is not possible.

The result is:

$$grad ( E ) ( {i}_{r x} , {i}_{r y} , {i}_{rcoul} ) = grad ( {D}_{1} ) ( {i}_{r x} , {i}_{r y} , {i}_{rcoul} ) + {β}_{1} grad ( {P}_{1} ) ( {i}_{r x} , {i}_{r y} , {i}_{rcoul} ) + {β}_{2} grad ( {P}_{2} ) ( {i}_{r x} , {i}_{r y} , {i}_{rcoul} ) + … + {β}_{n} grad ( {P}_{n} ) ( {i}_{r x} , {i}_{r y} , {i}_{rcoul} )$$

The coefficients β₁, . . . βₙ, which are not necessarily fixed, are chosen so as to obtain the desired trade-off between image rendering fidelity with respect to the photosites of the at least one input image Iₑ, and the desired constraint of noise reduction, for example. Depending on the application, these coefficients can be modified according to the type of image, or regionalized by image part—which amounts to dividing the sum contained in each term Pᵢ into multiple sub-sums with different β coefficients, in order, if necessary, to best adapt the rendering of a noise-free image that is as faithful as possible to the measurements.

Technically speaking, for x, y not affected by a photosite detecting color c, grad(D₁) y is zero by definition (since no comparison of the rendered image is possible there). It is then necessary to choose the indicators in such a way as to make at least one grad(Pᵢ) non-zero, in order to create a choice constraint in these positions.

Alternatively, to determine the pixels outside the detection grid of the sensor 3 or at least one sensor 3, linear or cubic interpolation can be used, or any other method able to select points that do not degrade, preferably the image noise, that is, generally a method that favors low spatial frequencies over adjacent points. They can also be selected using a method that minimizes the aliasing of outlines, when these points belong to an object outline, according to a previously mentioned criterion to be implemented.

Then, for each position x, y, and each color i_{rcoul}:

$${C}_{k + 1} ( {i}_{r x} , {i}_{r y} , {i}_{rcoul} ) = {C}_{k} ( {i}_{r x} , {i}_{r y} , {i}_{rcoul} ) - G ⋆ grad ( E ) ( {i}_{r x} , {i}_{r y} , {i}_{rcoul} )$$

The value of the coefficient G can be calculated and, if necessary, adjusted at each iteration k, in order to avoid possible oscillation of the solution, but also its rapid convergence. The person skilled in the art can refer to the numerous methods in the literature for finding solutions to a function using Newton's gradient method.

Thus, the solution Cₖ₊₁(iᵣₓ, i_{ry}, i_{rcoul}) must end up minimizing the sum of Dᵢ and of all the αᵢ Pᵢ.

To this end, it is preferable to choose so-called convex functions for these different indicators, which in theory ensures the uniqueness of the desired solution. If this is not the case, additional iterations can be added, and the person skilled in the art can use thermal annealing methods, for example, to escape from local minima.

The iteration operation can be repeated in order to obtain, for example, a minimum value of grad(E)(iᵣₓ, i_{ry}, i_{rcoul}) below a certain threshold, at iteration k, which is then deemed to be the last. It is also possible to stop iterating after a certain number of iterations (considering that the adjustments should become negligible, or simply because the image rendering time would become too long.)

The resulting solution Cₖ(iᵣₓ, i_{ry}, i_{rcoul}) then represents the processed image. This triggers the exit from the iteration loop, and the rendered image I_{R}.

Overall, the first constraint on the D or D₁ function creates a force that tends to cause the rendered image to pass between the points of the image obtained on the sensor.

The P₁ or P₃ function creates a force that prevents neighboring points from deviating too much in value, for the 2 offered examples. It therefore reduces the noise of the rendered image compared to the potentially noisy initial image.

The P₂ function creates a force that limits the effects of aliasing on the edges of objects, for the example offered.

Other Dᵢ or Pᵢ functions can be added, or other ways of writing the iteration, in order, for example, to better model variations in image texture within objects, but this other example is of course not limitative, and many other ways of creating penalty methods are imaginable, in order to guide the rendering of the image towards one type of image or another.

By way of example, it is possible to guide the solution according to the invention towards a black-and-white image, simply by heavily penalizing the aforementioned U and V terms to force them to remain close to zero. Conversely, one may accentuate the color saturation of the resulting image by penalizing the luminance Y more. And, if necessary, depending on other criteria that may be sensitive to a particular characteristic of an image area. Again by way of example, it is possible to create a penalty function that if the green component has a strong local variation, but the other two, Red and Blue, do not, which may correspond to the foliage of a landscape, then the penalty is reduced, which would have the effect of eventually leaving more noise in the rendered image because the noise would be less perceptible in those areas. Therefore, the implementation examples of penalty functions are provided as examples only and do not constitute limitations on writing other types of penalty functions.

The image rendered at step k was previously written from Cₖ(iᵣₓ, i_{ry}, i_{rcoul}), where iᵣₓ and i_{ry} scan the set of indices of positions in the image field. And c the set of colors. Cₖ(iᵣₓ, i_{ry}, and i_{rcoul}) correspond to elementary objects, with zero intensity in all three colors outside a rectangle (or generally a square) represented by their center located at (x, y), and with sides being the discretization step of positions xᵣ and yᵣ.

A further implementation can therefore preferably provide better results by agglomerating these squares when they are contiguous and of a similar optical property, in the sense, for example, of the same type of operation as that described for the penalty P₁ or P₃.

In order to locally replace these elementary patterns with larger objects, when the elementary kernel of calculation of P₁(x, y, c) or P₃(x, y, c) is below a certain threshold, at each point (x, y), an object can then be created called Oₘ whose index m allows it to be arranged in a list of objects, to which one transfers, for example, an average of the properties of the c e {1 . . . n_{c}} components Cₖ(x, y, c) for example. The object Oₘ can then be supplemented with a vectorized outline description, that is, no longer resulting from the joining of the initial squares, but from the parameterization of a line describing this boundary. This line can then be created to avoid rendering the aliasing of the pixels.

As far as Oₘₖ objects are concerned, they can generally be selected from a base of objects, such as elementary geometric shapes (rectangles, circles, curved lines, etc.).

The way of representing the image rendered in step k can then also be written:

$${I}_{k} = {\sum }_{m} {O}_{m k} \qquad [ Math . 6 ]$$

where each Oₘₖ represents a non-zero function on only part of the image.

The Dᵢ function(s) and Pᵢ penalty(-ies) are then written as involving these Oₘₖ(x, y, c), that is, the value of object m at a position x, y of the sensor field, and expressed for a color component.

For those parts of the image I_{Rk} or I_{R} where it has not been possible to create an object that brings together multiple squares, these squares can be included in the list of Oₘₖ objects, which is then extended with these square objects with side pₓ, p_{y} the discretization steps x, y, known as elementary objects.

All that is then left to do is add up the above indicators on m, the set of objects, in order to calculate them, in addition to the sum on x, y, c.

Formally, this representation of the image I_{Rk} or I_{R} makes it possible, for example, to take objects that contain properties of their own that can limit the number of calculations. Similarly, the additional calculations required to change the values at pixels other than those from sensor 3 or the at least one sensor 3, at each iteration k, can be eliminated, since the value of the color signals can be known as soon as the object is verified only at the photosites of the input image Iₑ (or input images Iₑ).

Also, operations and penalty calculations to avoid aliasing can be reduced if objects are naturally not aliased.

Of course, as already mentioned in the description of the gradient operator, in the same way that the method 1 can calculate the derivative of one of the penalties Pᵢ, with respect to variations in the elementary properties of each Cₖ(iᵣₓ, i_{ry}, i_{rcoul}), so that they can be adjusted at each iteration, these gradients can be calculated formally or by finite difference with respect to the properties of the object Oₘₖ, such as variations in parameters describing the positions of its outline, as well as the n_{c} color parameters, supplemented if necessary by parameters of internal color variations within the object, for example.

To evaluate the gradient of distances Dᵢ, it is of course also possible to calculate how this distance evolves in relation to variations in Oₘₖ parameters.

We may add that it is not necessary for the objects created to be considered as strictly spatially disjoint. Overlapping with neighboring objects can be allowed. In this way, this degree of freedom can perfect the description of the image I_{Rk} or I_{R}, for example that the set of properties of the larger object does not allow the full fineness of color variation in the object inside to be represented. An area of the image I_{Rk} or I_{R} can be described by a background object, to which spatially finer objects within it add color variations, more locally with respect to the set dP₁(x, y, c) of the object, even if these objects remain elementary Cₖ(iᵣₓ, i_{ry}, i_{rcoul}).

Also, the convolution products between the local PSFs and the pixels of the image I_{Rk} being rendered at step k can be pre-calculated with respect to the entire object Oₘₖ, which can reduce the number of calculations to be performed at each iteration.

The advantages of the first variant are:
it does not produce a reduction in sharpness at a noise reduction step, which must then be compensated for, with difficulty, in order to maintain a good level of compensation throughout the image.
it avoids the appearance of colored fringes often visible around the outlines of objects in the image.
it avoids the appearance of color noise (a kind of red, green or blue snow) within the texture of objects, or more generally in certain areas of the image.
it includes all corrections for distortion and loss of sharpness in the rendered image, evenly and accurately across the entire image.
it improves sharpness over the entire depth of field (in Z) of the image and/or over all image pixels, beyond the sharpness area of the hyperfocal distance, provided that the Z of each object is taken into account in the PSF(x,y,c)s
it avoids so-called zipper effects on object outlines.
it avoids false color effects in parts of the textures of the objects.
it renders far better-resolved image than the prior art, at equivalent pixel density (generally equal to the photosite pitch, but not always). In order to fully render the fineness of the image, it is preferable to export it by its objects, such as those described, directly. Any prior art compression or rendering generally degrading quality.

### Second Variant

The second variant of the method 1 comprises the application (by means 6) of the inverse invF(d0, Z0, a, b) of the function F(d0, Z0, a, b) which comprises a convolution, preferably non-iterative, of the inverse invF(d0, Z0, a, b) of the function F(d0, Z0, a, b) with each point or area of the at least one input image Iₑ.

According to variant 2, it is then necessary (by means 6), to:
estimate the parameters of each area or point of the image, in particular: their coordinates (a, b), the current distance d0, and the distance Zo, between the lens and the observed point in the scene.
generate invPSF(d0, Zo, a, b)
each invPSF can then be convolved with each image area.
The result is a flat image I_{R}, which is sharp everywhere.

In a preferred embodiment, the following steps are carried out (by means 6):

To summarize this method, the invPSF functions are calculated in such a way that invPSF, spatially convolved with PSF, approaches a Dirac function, as described above. This is made possible by performing a 2D Fourier transform TF2D(PSF) of the PSF coefficients function, with the PSF expanded over a large enough area, even if it means adding zero coefficients, or even expanded to the entire image. This provides a series of coefficients [symbol] . We then calculate

[symbol]

=1/ [symbol] and then

invPSF=TF2D⁻¹( [symbol] )

where TF2D⁻¹ is the inverse Fourier transform.

However, this procedure is generally not suitable for variant 2 of the method, as the basis of the functions implicitly used for the Fourier transform are non-zero over a domain generally exceeding the typical dimension of the image parts at each different Z, so that this procedure for inverting a PSF function does not work with this embodiment of the method according to the invention, which strongly differentiates the PSF values according to a and b, among other things, when Z changes significantly.

The following procedure is then followed (by means 6), which can be adapted according to the specifics of the images to be processed:
Observe the typical dimensions (e.g. number of pixels on the camera, that is, variation in a and variation in b) of the areas measured at a certain distance Z for each part of the image, and deduce therefrom a parameter d_typical. If necessary, this d_typical can also depend on (a, b).
Alternatively, this d_typical can be entered a priori as method data. It corresponds to the average dimensions of the image objects projected onto the image sensor.
It is then possible to consider a function basis (Bᵢ), preferably orthogonal to one another—each function describing a set of coefficients representing a PSF function, i an index from 1 to an integer K−. The basis (Bi) may, for example, be a set of Haar wavelets.
Next, PSF(d0, Zo, a, b) is broken down on this function basis, in the manner of a Fourier transform, but on this function basis: the matrix of PSF values is written as a sum of coefficient (vi) times the function Bi:

$$PSF = {\sum }_{i = 1}^{K} {ν}_{i} {B}_{i} + δ PSF$$

where δPSF is a residual function if the basis of (Bi) does not allow exhaustive representation of all the details of the PSF function and K represents the number of functions in the basis and is a natural number greater than 1, which is the chosen number of functions in the basis.

To calculate the (σi), the Dirac function δ( ) is projected onto the basis (Bi), resulting in a set of coefficients (γi). This set of coefficients can be modified to produce certain effects, such as the amplification of certain components or, on the contrary, their reduction (for example, if the image contains noise, it is possible to reduce the coefficients facing the fast-varying Bi functions, or conversely, increase them if the image has no noise, to increase the transitions between parts of the image), resulting in a set known as (γi′).

Then we calculate for each i

$${σ}_{i} = \frac{{γ}_{i}^{′}}{{ν}_{i}}$$

This is used to calculate the invPSF function defined below as equal to

$$invPSF = {\sum }_{i = 1}^{K} {σ}_{i} {B}_{i}$$

In each (a, b), there is a different invPSF function by the method shown. In order to limit calculations, invPSF functions can be obtained by translation (along a and b) of an invPSF (ac, bc) function as long as Zo remains close to Zoc and/or the PSF does not vary significantly from that obtained at a so-called center position (ac, bc), after compensating for the translation between (a, b) and (ac, bc). The point (a, b) is therefore a point that we sweep around the so-called “center” point with coordinates (ac, bc) in this case.

### Applications

Within the scope of the present description, it is also proposed according to the invention:
a smartphone (also called a computer-phone or smart cell phone or multifunction cell phone), implementing any one of the embodiments of the method according to the invention just described to correct an image acquired by the smartphone (more precisely by the camera module(s), comprising a lens and a sensor, of the smartphone) and/or comprising any one of the embodiments of a device according to the invention just described, arranged and/or programmed to correct an image acquired by the smartphone (more precisely by the camera module(s), comprising a lens and a sensor, of the smartphone), and/or
use of any of the device embodiments according to the invention just described and/or any of the method embodiments according to the invention just described within a smartphone (also called a computer-phone or smart cell phone or multifunction cell phone), to correct an image acquired by the smartphone (more precisely by the camera module(s), comprising a lens and a sensor, of the smartphone), and/or
a touch-sensitive tablet, implementing any one of the method embodiments according to the invention just described to correct an image acquired by the touch-sensitive tablet (more precisely by the camera module(s), comprising a lens and a sensor, of the touch-sensitive tablet) and/or comprising any one of the device embodiments according to the invention just described arranged and/or programmed to correct an image acquired by the touch-sensitive tablet (more precisely by the camera module(s), comprising a lens and a sensor, of the touch-sensitive tablet), and/or
use of any of the device embodiments according to the invention just described and/or any of the method embodiments according to the invention just described within a touch-sensitive tablet, to correct an image acquired by the touch-sensitive tablet (more precisely by the camera module(s), comprising a lens and a sensor, of the touch-sensitive tablet), and/or
a camera (preferably of the reflex or bridge or compact type), implementing any one of the method embodiments according to the invention just described to correct an image acquired by the camera (more precisely by the camera module(s), comprising a lens and a sensor, of the camera) and/or comprising any one of the device embodiments according to the invention just described arranged and/or programmed to correct an image acquired by the camera (more precisely by the camera module(s), comprising a lens and a sensor, of the camera),
use of any of the device embodiments according to the invention just described and/or any of the method embodiments according to the invention just described within a camera (preferably of the reflex or bridge or compact type), to correct an image acquired by the camera (more precisely by the camera module(s), comprising a lens and a sensor, of the camera), and/or
a vehicle (preferably automotive, but may be of any type), implementing any one of the method embodiments according to the invention just described to correct an image acquired by the vehicle (more precisely by the camera module(s), comprising a lens and a sensor, of the vehicle) and/or comprising any one of the device embodiments according to the invention just described arranged and/or programmed to correct an image acquired by the vehicle (more precisely by the camera module(s), comprising a lens and a sensor, of the vehicle); the corrected image preferably being used or intended to be used by the vehicle for autonomous driving of the vehicle, and/or
use of any one of the device embodiments according to the invention just described and/or of any one of the method embodiments according to the invention just described within a vehicle (preferably automotive, but may be of any type), to correct an image acquired by the vehicle (more precisely by the camera module(s), comprising a lens and a sensor, of the vehicle); the corrected image preferably being used or intended to be used by the vehicle for autonomous driving of the vehicle, and/or
a video surveillance system (preferably of a building and/or a geographical area), implementing any one of the method embodiments according to the invention just described to correct an image acquired by the video surveillance system (more precisely by the camera module(s), comprising a lens and a sensor, of the video surveillance system) and/or comprising any one of the device embodiments according to the invention just described arranged and/or programmed to correct an image acquired by the video surveillance system (more precisely by the camera module(s), comprising a lens and a sensor, of the video surveillance system), and/or
use of any of the device embodiments according to the invention just described and/or any of the method embodiments according to the invention just described within a video surveillance system (preferably of a building and/or a geographical area), to correct an image acquired by the video surveillance system (more precisely by the camera module(s), comprising a lens and a sensor, of the video surveillance system), and/or
a drone, implementing any one of the method embodiments according to the invention just described to correct an image acquired by the drone (more precisely by the camera module(s), comprising a lens and a sensor, of the drone) and/or comprising any one of the device embodiments according to the invention just described arranged and/or programmed to correct an image acquired by the drone (more precisely by the camera module(s), comprising a lens and a sensor, of the drone); the corrected image preferably being used or intended to be used by the drone:
   in the field of agriculture, the image acquired by the drone preferably being an image of plant crops, and/or
   in the field of pollution and/or land use analysis, the image acquired by the drone preferably being a multispectral image, and/or
use of any one of the device embodiments according to the invention just described and/or of any one of the method embodiments according to the invention just described within a drone to correct an image acquired by the vehicle (more precisely by the camera module(s), comprising a lens and a sensor, of the vehicle); the corrected image preferably being used or intended to be used by the drone:
   in the field of agriculture, the image acquired by the drone preferably being an image of plant crops, and/or
   in the field of pollution and/or land use analysis, the image acquired by the drone preferably being a multispectral image, and/or
a satellite, implementing any one of the method embodiments according to the invention just described to correct an image acquired by the satellite (more precisely by the camera module(s), comprising a lens and a sensor, of the satellite) and/or comprising any one of the device embodiments according to the invention just described arranged and/or programmed to correct an image acquired by the satellite (more precisely by the camera module(s), comprising a lens and a sensor, of the satellite); the corrected image preferably being used or intended to be used by the satellite:
   in the field of agriculture, the image acquired by the satellite preferably being an image of plant crops, and/or
   in the field of pollution and/or land use analysis, the image acquired by the satellite preferably being a multispectral image, and/or
use of any one of the device embodiments according to the invention just described and/or of any one of the method embodiments according to the invention just described within a satellite to correct an image acquired by the satellite (more precisely by the camera module(s), comprising a lens and a sensor, of the satellite); the corrected image preferably being used or intended to be used by the satellite:
   in the field of agriculture, the image acquired by the satellite preferably being an image of plant crops, and/or
   in the field of pollution and/or land use analysis, the image acquired by the satellite preferably being a multispectral image, and/or
an apparatus for medical imaging of the human and/or animal body (preferably by MRI and/or X-ray and/or Gamma-ray and/or ultrasound), implementing any one of the method embodiments according to the invention just described to correct an image acquired by the medical imaging apparatus and/or comprising any one of the device embodiments according to the invention just described arranged and/or programmed to correct an image acquired by the medical imaging apparatus, and/or
use of any one of the device embodiments according to the invention just described and/or any one of the method embodiments according to the invention just described within an apparatus for medical imaging of the human and/or animal body (preferably by MRI and/or X-ray and/or Gamma-ray and/or ultrasound), to correct an image acquired by the medical imaging apparatus, and/or
a microscopy apparatus, implementing any one of the method embodiments according to the invention just described for correcting an image acquired by the microscopy apparatus and/or comprising any one of the device embodiments according to the invention just described arranged and/or programmed for correcting an image acquired by the microscopy apparatus, and/or
use of any one of the device embodiments according to the invention just described and/or any one of the method embodiments according to the invention just described within a microscopy apparatus, to correct an image acquired by the microscopy apparatus, and/or
an apparatus for tomographic imaging of an image acquired in a plurality of spectra (preferably in the field of health and/or in the field of industry and/or in the field of agriculture), implementing any one of the method embodiments according to the invention just described to correct an image acquired by the tomographic imaging apparatus and/or comprising any one of the device embodiments according to the invention just described arranged and/or programmed to correct an image acquired by the tomographic imaging apparatus, and/or
use of any one of the device embodiments according to the invention just described and/or any one of the method embodiments according to the invention just described within a tomographic imaging apparatus of an image acquired in multiple spectra (preferably in the field of health and/or in the field of industry and/or in the field of agriculture), to correct an image acquired by the tomographic imaging apparatus, and/or
a computer program comprising instructions which, when executed by a computer, implement the steps of the method according to the invention just described, and/or
a computer program product comprising instructions which, when the program is executed by a computer, cause the computer to perform the steps of the method according to the invention just described, and/or
computer-readable storage medium comprising instructions which, when executed by a computer, cause the computer to perform the steps of the method according to the invention just described.

Of course, the invention is not limited to the examples just described, and many adjustments can be made to these examples without going beyond the scope of the invention.

In particular, each passage of the preceding description mentioning a sensor 3, an imaging system 4 or an input image Iₑ or a camera module can be generalized respectively to at least one sensor 3, at least one imaging system 4 or at least one input image Iₑ or at least one camera module.

Of course, the various features, forms, variants and embodiments of the invention may be combined with each other in various combinations as long as they are not incompatible or exclusive of each other. In particular, all the variants and embodiments described above can be combined with each other.

1. A method for correcting the sharpness of at least one input image Iₑ into a rendered image I_{R}, the at least one input image Iₑ originating from at least one optical sensor and being obtained through at least one optical imaging system, each sensor being associated with an optical imaging system, said method comprising:
receiving the at least one input image Iₑ comprising different points or areas imaging different imaged parts located at different distances from the sensor that acquired the point or area in question;
acquisition or determination, by technical processing means, of information relating, for each point or area coordinate (a, b) of the at least one input image Iₑ, to:
a distance Z0 between, on the one hand, the imaged part corresponding to this point or area of the at least one input image Iₑ and, on the other hand, the imaging system or sensor that acquired this point or area of the at least one input image Iₑ;
a setting of the at least one imaging system for the at least one input image Iₑ or a distance d0 between the sensor and the imaging system that acquired this point or area of the at least one input image Iₑ:
a selection or construction, by the technical processing means, of a function F(d0, Z0, a, b) describing the response of the at least one imaging system, preferably optical transfer (OTF) or point spread (PSF) of the at least one imaging system, and which depends, for each point or area coordinate (a, b) of the at least one input image Iₑ:
on the distance Z0 between, on the one hand, the imaged part corresponding to this point or area of the at least one input image Iₑ and, on the other hand, the imaging system or sensor that acquired this point or area of the at least one input image Iₑ;
on the setting of the at least one imaging system for the at least one input image Iₑ or the distance d0 between the sensor and the imaging system that acquired this point or area of the at least one input image Iₑ;
and preferably on coordinates (a, b);
an application, by the technical processing means, of the function F(d0, Z0, a, b) or of an inverse invF(d0, Z0, a, b) of the function F(d0, Z0, a, b) to each point or area coordinate (a, b) of the at least one input image Iₑ, to obtain the rendered image I_{R}.

2. The method according to claim 1, characterized in that the inverse invF(d0, Z0, a, b) of the function F(d0, Z0, a, b) is defined so that the convolution product of the inverse invF(d0, Z0, a, b) of the function F(d0, Z0, a, b) and the function F(d0, Z0, a, b) is a two-dimensional Dirac function or substantially a two-dimensional Dirac function.

3. The method according to claim 1, characterized in that the function F(d0, Z0, a, b) depends on a numerical aperture of the at least one imaging system for acquiring the at least one input image Iₑ.

4. The method according to claim 1, characterized in that each optical sensor is provided with photosites of different colors.

5. The method according to claim 1, characterized in that the function describing the response of the at least one imaging system is an optical transfer function (OTF) of the at least one imaging system or a point spread function (PSF) of the at least one imaging system.

6. The method according to claim 1, characterized in that the function describing the response of the at least one imaging system depends:
on a distance (z_{co}) between a part of the at least one imaging system and the at least one sensor, and/or
on a state of the at least one imaging system, such as a zoom or focus or numerical aperture setting of the at least one imaging system, and/or
on the pixel of the image being displayed and/or the photosite of the at least one sensor, and/or
on one or more angles between the at least one sensor and the at least one imaging system.

7. The method according to claim 1, characterized in that it comprises passing light through the at least one imaging system to the at least one sensor so as to generate the at least one input image.

8. The method according to claim 1, characterized in that it comprises displaying the rendered image on a screen.

9. The method according to claim 1, characterized in that the rendered image has a resolution greater than or equal to that of the combination of all the photosites of all the colors of the at least one sensor.

10. The method according to claim 1, characterized in that the application of the function F(d0, Z0, a, b) comprises an iterative convolution of the function F(d0, Z0, a, b) with each point or area of the at least one input image Iₑ so as to obtain at each iteration an image being rendered I_{Rk} and then the rendered image I_{R} at the end of the iterations.

11. The method according to claim 10, characterized in that:
the iterative convolution comprises an iterative modification of the image I_{Rk} being rendered at different iterations k, by iterative processing of a function E comprising two terms including:
a first term D which depends on a comparison between, on the one hand, the at least one input image Iₑ and, on the other hand, a result I_{ck} of the image I_{Rk} being rendered at iteration k reprocessed by information relating to the at least one imaging system, the first term D depending on difference(s) between, on the one hand, the at least one input image Iₑ and, on the other hand, the result I_{ck} of a modification of the image I_{Rk} being rendered at iteration k at least by the function F(d0, Z0, a, b) describing the response of the at least one imaging system, the function describing the response of the at least one imaging system depending on a distance (Z) between the at least one sensor and an object imaged by the at least one sensor, and/or a distance (zₒₛ) between a part of the at least one imaging system and an object imaged by the at least one sensor, and
a second term P which depends on anomaly(ies) or penalty(ies) or defect(s) within the image I_{Rk} being rendered at iteration k,
until a cumulative effect is minimized, at least below a certain minimization threshold or after a certain number of iterations, the effect being cumulative of:
difference(s) in the first term D between the at least one input image Iₑ and the result I_{ck}, and
anomaly(ies) or penalty(ies) or defect(s) on which the second term P depends within the image I_{Rk} being rendered at iteration k;
so that the rendered image I_{R} corresponds to the image being rendered at the iteration for which this minimization is obtained.

12. The method according to claim 11, characterized in that it simultaneously corrects at least two of the following types of defects in the at least one input image from:
Optical, geometric and/or chromatic aberration, and/or
Distortion, and/or
Mosaic artifacts, and/or
Detection noise, and/or
Blur, and/or
Residual non-compensation for motion, and/or
Artifacts induced by spatial discretization.

13. The method according to claim 11, characterized in that the minimization of the cumulative effect corresponds to a minimization of the function E.

14. The method according to claim 11, characterized in that the function E comprises the sum of the first term D and the second term P.

15. The method according to claim 11, characterized in that the result I_{ck} comprises and/or consists of a convolution product of the image I_{Rk} being rendered at iteration k by the function describing the response of the at least one imaging system, and optionally processed by a geometric transformation GT.

16. The method according to claim 11, characterized in that it comprises generating, from multiple input images, an initial version of the image being rendered I_{Rk} for the first iteration k=1 by a combination between these multiple input images Iₑ.

17. The method according to claim 11, characterized in that the second term P comprises at least one component P₁ whose effect is minimized for small differences in intensity between neighboring pixels of the image I_{Rk} being rendered at iteration k.

18. The method according to claim 11, characterized in that the second term P comprises at least one component P₃ whose effect is minimized for small differences in hue between neighboring pixels of the image I_{Rk} being rendered at iteration k.

19. The method according to claim 11, characterized in that the second term P comprises at least one component P₂ whose effect is minimized for low frequencies of direction changes between neighboring pixels of the I_{Rk} image drawing a contour.

20. The method according to claim 1, characterized in that the application of the inverse invF(d0, Z0, a, b) of the function F(d0, Z0, a, b) comprises a convolution, preferably non-iterative, of the inverse invF(d0, Z0, a, b) of the function F(d0, Z0, a, b) with each point or area of the at least one input image Iₑ.

21. A device for correcting the sharpness of at least one input image Iₑ into a rendered image I_{R}, the at least one input image Iₑ originating from at least one optical sensor and being obtained through at least one optical imaging system, each sensor being associated with an optical imaging system, said method comprising:
means for receiving the at least one input image Iₑ comprising different points or areas imaging different imaged parts located at different distances from the sensor that acquired the point or area in question;
technical processing means arranged and/or programmed for acquiring or determining information relating, for each point or area coordinate (a, b) of the at least one input image Iₑ, to:
a distance Z0 between, on the one hand, the imaged part corresponding to this point or area of the at least one input image Iₑ and, on the other hand, the imaging system or sensor that acquired this point or area of the at least one input image Iₑ;
a setting of the at least one imaging system for the at least one input image Iₑ or a distance d0 between the sensor and the imaging system that acquired this point or area of the at least one input image Iₑ;
the technical processing means being further arranged and/or programmed for:
a selection or construction of a function F(d0, Z0, a, b) describing the response of the at least one imaging system, preferably optical transfer (OTF) or point spread (PSF) of the at least one imaging system, and which depends, for each point or area coordinate (a, b) of the at least one input image Iₑ:
on the distance Z0 between, on the one hand, the imaged part corresponding to this point or area of the at least one input image Iₑ and, on the other hand, the imaging system or sensor that acquired this point or area of the at least one input image Iₑ;
on the setting of the at least one imaging system for the at least one input image Iₑ or the distance d0 between the sensor and the imaging system that acquired this point or area of the at least one input image Iₑ;
and preferably on coordinates (a, b);
an application of the function F(d0, Z0, a, b) or of an inverse invF(d0, Z0, a, b) of the function F(d0, Z0, a, b) to each point or area coordinate (a, b) of the at least one input image Iₑ, to obtain the rendered image I_{R}.

22. The device according to claim 21, characterized in that the inverse invF(d0, Z0, a, b) of the function F(d0, Z0, a, b) is defined so that the convolution product of the inverse invF(d0, Z0, a, b) of the function F(d0, Z0, a, b) and the function F(d0, Z0, a, b) is a two-dimensional Dirac function or substantially a two-dimensional Dirac function.

23. The device according to claim 21, characterized in that the function F(d0, Z0, a, b) depends on a numerical aperture of the at least one imaging system for acquiring the at least one input image Iₑ.

24. The device according to claim 21, characterized in that each optical sensor is provided with photosites of different colors.

25. The device according to claim 21, characterized in that the application of the function F(d0, Z0, a, b) comprises an iterative convolution of the function F(d0, Z0, a, b) with each point or area of the at least one input image Iₑ, so as to obtain at each iteration an image being rendered I_{Rk} and then the rendered image I_{R} at the end of the iterations.

26. The device according to claim 25, characterized in that:
the technical processing means are arranged and/or programmed for iterative modification of the image I_{Rk} being rendered at different iterations k, by iterative processing of a function E comprising two terms of which:
a first term D which depends on a comparison between, on the one hand, the at least one input image Iₑ and, on the other hand, a result I_{ck} of the image I_{Rk} being rendered at iteration k reprocessed by information relating to the at least one imaging system, the first term D depending on difference(s) between, on the one hand, the at least one input image Iₑ and, on the other hand, the result I_{ck} of a modification of the image I_{Rk} being rendered at iteration k at least by the function F(d0, Z0, a, b) describing the response of the at least one imaging system, the function describing the response of the at least one imaging system depending on a distance (Z) between the at least one sensor and an object imaged by the at least one sensor, and/or a distance (zₒₛ) between a part of the at least one imaging system and an object imaged by the at least one sensor, and
a second term P which depends on anomaly(ies) or penalty(ies) or defect(s) within the image I_{Rk} being rendered at iteration k,
until a cumulative effect is minimized, at least below a certain minimization threshold or after a certain number of iterations, the effect being cumulative of:
difference(s) in the first term D between the at least one input image Iₑ and the result I_{ck}, and
anomaly(ies) or penalty(ies) or defect(s) on which the second term P depends within the image I_{Rk} being rendered at iteration k;
so that the rendered image I_{R} corresponds to the image being rendered at the iteration for which this minimization is obtained.

27. The device according to claim 21, characterized in that the application of the inverse invF(d0, Z0, a, b) of the function F(d0, Z0, a, b) comprises a convolution, preferably non-iterative, of the inverse invF(d0, Z0, a, b) of the function F(d0, Z0, a, b) with each point or area of the at least one input image Iₑ.
